(19) United States
(12) Patent Application Publication
(10) Pub. No.: US 2026/0135891 A1
(43) Pub. Date: May 14, 2026

(54) SESSION MANAGEMENT METHOD APPLYING NON-3GPP DEVICE RELATED INFORMATION TO SESSION OF MOBILE COMMUNICATION NETWORK AND COMMUNICATION SYSTEM PROVIDING THE SAME

(71) Applicant: ELECTRONICS AND TELECOMMUNICATIONS RESEARCH INSTITUTE, Daejeon (KR)

(72) Inventor: Soohwan LEE, Daejeon (KR)

(21) Appl. No.: 19/379,300

(22) Filed: Nov. 4, 2025

(30) Foreign Application Priority Data
Nov. 4, 2024 (KR) 10-2024-0154582
Nov. 8, 2024 (KR) 10-2024-0158414
Nov. 3, 2025 (KR) 10-2025-0162847

(51) Int. Cl. H04L 65/1069; H04L 69/322

(52) U.S. Cl. CPC H04L 65/1069; H04L 69/322

(57) ABSTRACT

A session management method performed by a core network according to an embodiment of the present disclosure includes receiving, by using an access and mobility management function (AMF), a packet data unit (PDU) session modification request to which non-3GPP device connection information is applied from a user equipment (UE) or a 5G residential gateway (5G-RG), and determining whether to reject the PDU session modification request by using at least one of a session management function (SMF) or a policy control function (PCF).

### CROSS-REFERENCE TO RELATED APPLICATIONS

This application claims priority to Korean Patent Applications No. 10-2024-0154582, filed on Nov. 4, 2024, No. 10-2024-0158414, filed on Nov. 8, 2024, and No. 10-2025-0162847, filed on Nov. 3, 2025, with the Korean Intellectual Property Office (KIPO), the entire contents of which are hereby incorporated by reference.

### BACKGROUND

### 1. Technical Field

The present disclosure relates to a communication technology field, and more particularly, to a technology for managing and updating a packet data unit (PDU) session of a mobile communication network.

### 2. Related Art

The description provided in this section is merely intended to provide background information related to the exemplary embodiments and does not constitute prior art.

In a wireless communication network, electronic devices such as a base station (BS) and a user equipment (UE) perform wireless communication with each other in order to transmit or receive data. Sensing is a process of acquiring information about surroundings of a device. Sensing may also be used to detect information about an object, such as location, speed, distance, direction, shape, texture, etc. Such information may be used to improve communication within a network, and may also be used for purposes specific to other applications.

Sensing in a communication network has typically been limited to active sensing techniques accompanied by a device that receives and processes radio frequency (RF) sensing reference signals. Other sensing techniques, such as passive sensing (for example, radar) and non-RF sensing (for example, video imaging and other sensors), may address some limitations of active sensing. However, such other sensing techniques are typically implemented as standalone systems independently of the communication network.

A 5G communication system has been designed with a focus on communication functions, and sensing technologies are performed in separate and independent systems. Sensing technologies that are independent of the communication system result in inefficient use of resources and act as major factors that degrade reliability and quality of integrated sensing data. Accordingly, there is a demand for improvements to address these issues.

### SUMMARY

The present disclosure has been derived to solve problems of the related art, and the present disclosure is directed to providing network functions and procedures for enhancing sensing services by using sensing devices, including terminals capable of using mobile communication services in a mobile communication system, wireless devices that are not capable of directly using mobile communication services, wired or wireless devices that use mobile communication services through a user equipment (UE) or a home gateway capable of using mobile communication services, or sensing devices.

The present disclosure is directed to providing network functions and procedures for enhancing sensing services by recognizing sensing devices of various frequency bands and wireless technologies that can be used in wireless technologies other than a mobile communication system, and by utilizing sensing based on such devices in a mobile communication network.

The present disclosure is directed to providing network functions and procedures that enable a user equipment (UE) or a 5G residential gateway (5G-RG), which recognizes a non-3GPP device serviced via the UE or the 5G-RG on paths of a control plane and a data plane of a mobile communication system, to differentiate Quality of Service (QoS) for a packet data unit (PDU) session used by the non-3GPP device or for each QoS flow within the PDU session.

The present disclosure is directed to providing procedures using a session management function (SMF) and/or a policy control function (PCF) so that a user equipment (UE) or a 5G residential gateway (5G-RG), which recognizes a non-3GPP device serviced via the UE or the 5G-RG on paths of a control plane and a data plane of a mobile communication system, can utilize the non-3GPP device within a mobile communication network.

According to an exemplary embodiment of the present disclosure, a method for session management of a mobile communication network may include receiving, by a core network, a packet data unit (PDU) session modification request with non-3GPP device connection information applied from a user equipment (UE) or a 5G residential gateway (5G-RG); and determining, by the core network, whether to reject the PDU session modification request using at least one of a session management function (SMF) or a policy control function (PCF).

In the method for session management of a mobile communication network according to an exemplary embodiment of the present disclosure, the determining whether to reject the PDU session modification request may include determining whether to reject the PDU session modification request based on whether a non-3GPP device identifier included in the non-3GPP device connection information applied to the PDU session modification request is available according to information stored in a unified data repository (UDR) for the UE or 5G-RG.

In the method for session management of a mobile communication network according to an exemplary embodiment of the present disclosure, the determining whether to reject the PDU session modification request may include determining using a unified data repository (UDR) whether a non-3GPP device identifier included in the non-3GPP device connection information applied to the PDU session modification request is available; determining using the PCF whether to reject a session management policy association modification request generated based on the PDU session modification request, based on whether the non-3GPP device identifier is available; and rejecting the PDU session modification request using the SMF based on the session management policy association modification request being rejected by the PCF.

In the method for session management of a mobile communication network according to an exemplary embodiment of the present disclosure, the determining whether to reject the PDU session modification request may further include notifying, using the PCF, a rejection of the session management policy association modification request, to the SMF, indicating that the non-3GPP device identifier is not available for the UE or 5G-RG, based on the session management policy association modification request being rejected.

The method for session management of a mobile communication network according to an exemplary embodiment of the present disclosure, based on the PDU session modification request being rejected, may further include notifying, using the SMF, a rejection of the PDU session modification request to the UE or 5G-RG via an access and mobility management function (AMF) together with a cause code notifying that the non-3GPP device identifier is not available for the UE or 5G-RG.

The method for session management of a mobile communication network according to an exemplary embodiment of the present disclosure may further include receiving, by the core network using the SMF, a session management context update request of a PDU session generated based on the PDU session modification request from an access and mobility management function (AMF).

The method for session management of a mobile communication network according to an exemplary embodiment of the present disclosure may further include updating, by the core network using the SMF and the PCF, session management context information based on the PDU session modification request so that the non-3GPP device connection information is applied.

According to another exemplary embodiment of the present disclosure, a method for session management in a mobile communication network, may include receiving, by a core network, a packet data unit (PDU) session modification request with non-3GPP device connection information applied from a user equipment (UE) or a 5G residential gateway (5G-RG) using an access and mobility management function (AMF); and transmitting, by the core network, a PDU session context update result or a PDU session modification result to which the non-3GPP device connection information is applied to the UE or the 5G-RG via the AMF.

The method for session management of a mobile communication network according to an exemplary embodiment of the present disclosure may further include receiving, by the core network using a session management function (SMF), a session management context update request generated from the AMF based on the PDU session modification request; and performing, by the core network using the SMF and a policy control function (PCF), a session management policy association modification procedure for differentiated QoS handling for traffic with the UE or the 5G-RG based on a non-3GPP device identifier included in the non-3GPP device connection information.

In the method for session management of a mobile communication network according to an exemplary embodiment of the present disclosure, the performing of the session management policy association modification procedure may include generating or updating, by the core network using the PCF, one or more Policy and Charging Control (PCC) rules based on the non-3GPP device identifier and a user plane address corresponding to the non-3GPP device identifier; determining, by the core network using the PCF, a Quality of Service (QoS) parameter within the one or more PCC rules based on the non-3GPP device identifier or an operator policy; and updating, by the core network using the SMF, a session management context for differentiated QoS handling for traffic with the UE or the 5G-RG based on the QoS parameter.

In the method for session management of a mobile communication network according to an exemplary embodiment of the present disclosure, the determining of the QoS parameter within the one or more PCC rules may include determining the QoS parameter in the one or more PCC rules based on an individual QoS parameter or a QoS reference associated with the non-3GPP device identifier obtained using the non-3GPP device identifier from a unified data repository (UDR).

The method for session management of a mobile communication network according to an exemplary embodiment of the present disclosure may further include updating, using the SMF, session management information of a user plane function (UPF) so that the non-3GPP device connection information is applied, after the receiving of the session management context update request.

In the method for session management of a mobile communication network according to an exemplary embodiment of the present disclosure, the transmitting of the PDU session context update result or the PDU session modification result to the UE or the 5G-RG via the AMF, may include responding, by the core network using the SMF, to the AMF with the PDU session context update result or the PDU session modification result to which the non-3GPP device connection information is applied; and notifying, by the core network using the AMF, the PDU session context update result or the PDU session modification result to which the non-3GPP device connection information is applied to the UE or the 5G-RG.

According to an exemplary embodiment of the present disclosure, a communication system providing a session management method may include at least one entity, and the at least one entity may include a memory storing at least one instruction readable in a computer; and a processor executing the at least one instruction.

The at least one entity may be configured to: receive a packet data unit (PDU) session modification request with non-3GPP device connection information applied from a user equipment (UE) or a 5G residential gateway (5G-RG) using an access and mobility management function (AMF); and determine whether to reject the PDU session modification request using at least one of a session management function (SMF) or a policy control function (PCF).

In the communication system according to an exemplary embodiment of the present disclosure, the at least one entity may be further configured to determine whether to reject the PDU session modification request based on whether a non-3GPP device identifier included in the non-3GPP device connection information applied to the PDU session modification request is available according to information stored in a unified data repository (UDR) for the UE or 5G-RG.

In the communication system according to an exemplary embodiment of the present disclosure, the at least one entity may be further configured to determine using a unified data repository (UDR) whether a non-3GPP device identifier included in the non-3GPP device connection information applied to the PDU session modification request is available; determine using the PCF whether to reject a session management policy association modification request generated based on the PDU session modification request, based on whether the non-3GPP device identifier is available; and reject the PDU session modification request using the SMF based on the session management policy association modification request being rejected by the PCF.

In the communication system according to an exemplary embodiment of the present disclosure, the at least one entity may be further configured to notify, using the PCF, a rejection of the session management policy association modification request, to the SMF, indicating that the non-3GPP device identifier is not available for the UE or 5G-RG, based on the session management policy association modification request being rejected, and notify, using the SMF, a rejection of the PDU session modification request to the UE or 5G-RG via an access and mobility management function (AMF) together with a cause code notifying that the non-3GPP device identifier is not available for the UE or 5G-RG.

In the communication system according to an exemplary embodiment of the present disclosure, the at least one entity may be further configured to transmit a PDU session context update result or a PDU session modification result to which the non-3GPP device connection information is applied to the UE or the 5G-RG via the AMF.

In the communication system according to an exemplary embodiment of the present disclosure, the at least one entity may be further configured to generate or update, using the PCF, one or more Policy and Charging Control (PCC) rules based on a non-3GPP device identifier included in the non-3GPP device connection information and a user plane address corresponding to the non-3GPP device identifier; determine, using the PCF, a Quality of Service (QoS) parameter within the one or more PCC rules based on the non-3GPP device identifier or an operator policy; and update, using the SMF, a session management context for differentiated QoS handling for traffic with the UE or the 5G-RG based on the QoS parameter.

In the communication system according to an exemplary embodiment of the present disclosure, the non-3GPP device connection information may include a user plane address and a device identifier bound to a non-3GPP device for QoS differentiation between PDU sessions to which the UE or the 5G-RG is associated, or for differentiation between QoS flows within a PDU session to which the UE or the 5G-RG is associated.

According to exemplary embodiments of the present disclosure, network functions and procedures for enhancing sensing services may be implemented by using wireless devices that are not capable of directly using mobile communication services, wired or wireless devices that use mobile communication services through a user equipment (UE) or a home gateway capable of using mobile communication services, or sensing devices.

According to exemplary embodiments of the present disclosure, network functions and procedures for enhancing sensing services may be implemented by recognizing sensing devices of various frequency bands and wireless technologies that can be used in wireless technologies other than a mobile communication system, and by utilizing sensing based on such devices in a mobile communication network.

According to exemplary embodiments of the present disclosure, a user equipment (UE) or a 5G residential gateway (5G-RG) that recognizes a non- 3GPP device serviced via the UE or the 5G-RG on paths of a control plane and a data plane of a mobile communication system may differentiate Quality of Service (QoS) for a packet data unit (PDU) session used by the non-3GPP device or for each QoS flow within the PDU session.

According to exemplary embodiments of the present disclosure, by using a session management function (SMF) and/or a policy control function (PCF) in a core network, a user equipment (UE) or a 5G residential gateway (5G-RG) that recognizes a non- 3GPP device serviced via the UE or the 5G-RG on paths of a control plane and a data plane of a mobile communication system may utilize the non-3GPP device within the mobile communication network.

### BRIEF DESCRIPTION OF DRAWINGS

FIG. 1 is a diagram conceptually illustrating a wireless signal-based sensing service including a wireless sensing user equipment (UE) that recognizes and utilizes a non-3GPP device, and a core network supporting the sensing service, according to an exemplary embodiment of the present disclosure.

FIG. 2 is a diagram conceptually illustrating an architecture of the core network of FIG. 1.

FIGS. 3 to 6 are operation flowcharts illustrating processes among an associated UE associated with a non-3GPP device, a (R)AN, and a plurality of network functions in a core network, for a session management method according to an exemplary embodiment of the present disclosure.

FIG. 7 is an operation flowchart illustrating a session management method for utilizing a non-3GPP device within a mobile communication network, according to an exemplary embodiment of the present disclosure.

FIG. 8 is an operation flowchart illustrating a session management method for utilizing a non-3GPP device within a mobile communication network, according to another exemplary embodiment of the present disclosure.

FIG. 9 is a conceptual diagram illustrating an example of a generalized computing system in which one or more of a UE associated with a non-3GPP device, an (R)AN, entities within a core network 200, or sensing entities interacting with the core network 200 and participating in a sensing process may be implemented to perform one or more of the processes of FIGS. 1 through 8.

### DETAILED DESCRIPTION OF THE EMBODIMENTS

While the present disclosure is capable of various modifications and alternative forms, specific embodiments thereof are shown by way of example in the drawings and will herein be described in detail. It should be understood, however, that there is no intent to limit the present disclosure to the particular forms disclosed, but on the contrary, the present disclosure is to cover all modifications, equivalents, and alternatives falling within the spirit and scope of the present disclosure. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term “and/or” includes any and all combinations of one or more of the associated listed items.

In exemplary embodiments of the present disclosure, “at least one of A and B” may refer to “at least one A or B” or “at least one of one or more combinations of A and B”. In addition, “one or more of A and B” may refer to “one or more of A or B” or “one or more of one or more combinations of A and B”.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between,” “adjacent” versus “directly adjacent,” etc.).

The terminologies are used herein for the purpose of describing particular exemplary embodiments only and are not intended to limit the present disclosure. The singular forms include plural referents as well unless the context clearly dictates otherwise. Also, the expressions “comprises,” “includes,” “constructed,” “configured” are used to refer a presence of a combination of stated features, numbers, processing steps, operations, elements, or components, but are not intended to preclude a presence or addition of another feature, number, processing step, operation, element, or component.

Unless defined otherwise, all terms used herein, including technical or scientific terms, have the same meaning as commonly understood by those of ordinary skill in the art to which the present disclosure pertains. Terms such as those defined in a commonly used dictionary should be interpreted as having meanings consistent with their meanings in the context of related literatures and will not be interpreted as having ideal or excessively formal meanings unless explicitly defined in the present application.

Meanwhile, one or more conventional components may be included in a configuration of the present disclosure if necessary, and such components will be described herein to an extent that it does not obscure the technical idea and concept of the present disclosure. If the description of the conventional components may obscure the technical idea and concept of the present disclosure, however, detailed description of such components may be omitted for simplicity.

However, the spirit of the present disclosure is not intended to claim rights to such well-known technologies, and the contents of such well-known technologies may be included as part of the present disclosure within a scope that does not depart from the spirit of the present disclosure.

Exemplary embodiments of the present disclosure will now be described in detail with reference to the accompanying drawings. In the drawings, the same components may be designated by the same reference numerals to facilitate overall understanding of the disclosure, and duplicate descriptions thereof will be omitted for simplicity.

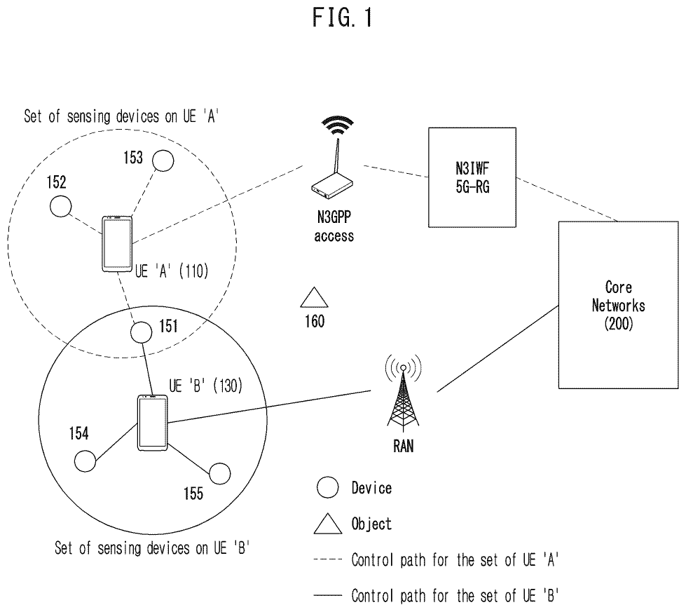

FIG. 1 is a diagram conceptually illustrating a wireless signal-based sensing service including a wireless sensing user equipment (UE) that recognizes and utilizes a non-3GPP device, and a core network supporting the sensing service, according to an exemplary embodiment of the present disclosure.

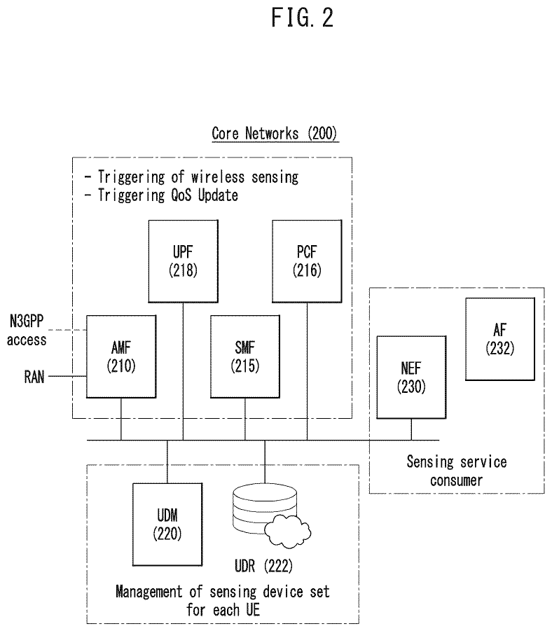

FIG. 2 is a diagram conceptually illustrating an architecture of the core network of FIG. 1.

For implementation and operation of the embodiments of FIGS. 1 and 2, at least a portion of integrated sensing and communication (ISAC) technology may be used within a range that does not contradict the object of the present disclosure.

As shown in FIGS. 1, 2, and FIG. 9 to be described later, a user equipment (UE) that recognizes and utilizes a non-3GPP device according to an exemplary embodiment of the present disclosure, entities in a core network 200 that utilize wireless sensing UEs including non-3GPP devices for sensing, and/or sensing entities that are involved in a sensing process by a wireless signal-based sensing service may include a memory 1200 storing at least one instruction readable by a computer and a processor 1100 executing the at least one instruction.

The core network 200 may include various network functions (NFs). In addition to functions illustrated in FIG. 1 or FIG. 2 and functions not illustrated, the core network 200 may exemplarily include an application function (AF) 232, an access and mobility management function (AMF) 210, an application service provider (ASP), a location management function (LMF), a network exposure function (NEF) 230, operation, administration, and maintenance (OAM), a session management function (SMF) 215, a policy control function (PCF) 216, unified data management (UDM) 220, a unified data repository (UDR) 222, a data network (DN) or a local part of a DN that supports local access, a user plane function (UPF) 218, a (radio) access network ((R)AN), a user equipment (UE), and a 5G residential gateway (5G-RG).

The application service provider (ASP) function may be part of a network function of the core network 200, and at least a portion of the ASP function may be implemented in a form of a sensing client and provided to a user.

In an alternative exemplary embodiment of the present disclosure, the sensing client may include an ASP that uses a sensing service of a mobile communication network. In another alternative exemplary embodiment of the present disclosure, the sensing client may include an ASP and an ASP-implemented service executed in a form of an application in a UE environment.

The sensing client may have at least a portion of its functions implemented in a form of an application (App) in a user equipment (UE) to communicate with the UE, and may communicate with the core network via an application interface network function. In this case, the sensing client may include an ASP network function.

Each network function may support the following functions.

The AMF 210 provides functions for access and mobility management on a UE basis, and one service operated in a UE may be basically connected to one AMF 210.

The DN may mean, for example, an operator service, Internet access, or a third-party service. The DN may transmit a downlink protocol data unit (PDU) to the UPF 218 or may receive, from the UPF 218, a PDU transmitted from the UE. The local part of the DN may mean a data network that supports local access and has a short data transmission path, and may be used to refer to a DN in which an edge application server supporting edge computing services is deployed.

The PCF 216 may provide a function of receiving information on service-specific packet flows from an application server or a UE or a 5G-RG and determining policies for mobility management, session management, etc., suitable for each service. Specifically, the PCF 216 may support a unified policy framework for controlling network operations, provision of policy rules so that control plane function(s) (for example, AMF, SMF, etc.) may enforce the policy rules, and implementation of a front end for accessing subscription information related to policy decisions in the unified data repository (UDR).

The SMF 215 provides a session management function, and when a UE or a 5G-RG has a plurality of sessions, each session may be managed by a different SMF 215.

The UDM 220 may store subscription data of a UE or a 5G-RG, policy data, information on services used by the UE or the 5G-RG, information on network functions serving the UE or the 5G-RG, etc., in the UDR 222 or may provide the same to other network functions.

The UDR 222 may provide, to other network functions, services for storing, deleting, updating, and retrieving subscription data of a UE or a 5G-RG, policy data applicable to services used by the UE or the 5G-RG, device configuration information for UE or 5G-RG services, service rule information, etc.

The UPF 218 may deliver a downlink PDU received from the DN to the UE or the 5G-RG via the (R)AN, and may deliver an uplink PDU received from the UE or the 5G-RG via the (R)AN to the DN. An uplink classifier (ULCL) may refer to a UPF 218 having a function of classifying and transmitting uplink traffic. A local UPF (L-UPF) may perform a role of a PDU session anchor for a session transmitted to the local part of the DN.

A sensing network function (SNF) may be a network function that borrows at least a portion of network functions for supporting an integrated sensing and communication (ISAC) service. The sensing network function may perform at least one of operations of receiving an ISAC service request, performing authentication for the request, generating and configuring an ISAC service quality control policy, discovering and selecting network devices and terminals that perform sensing operations, and collecting and processing sensing results. The operations may be configured or implemented as two logically separated network functions, namely, a sensing service gateway/centre and a sensing management function.

For example, when configured or implemented as logically separated network functions, the sensing service gateway/centre may be deployed in a mobile communication core network to receive ISAC service requests and perform authentication operations, and to perform operations such as generation of ISAC service quality control policies. The sensing management function may be deployed in the mobile communication core network to perform operations such as discovering and selecting network devices and terminals to perform actual sensing operations, and collecting and processing sensing results. The present disclosure does not limit a method of configuring the sensing network function, and both an embodiment in which the sensing network function is configured as an integrated function and operates as one entity and an embodiment in which the sensing network function is configured as separated functions and operates separately may be included in the scope of the present disclosure. In an exemplary embodiment of the present disclosure, at least a portion of functions of the sensing service gateway/centre and the sensing management function may be included in functions of a sensing capability exposure function (SCEF) and/or a sensing service provisioning function (SePF) and/or a sensing entity control function (SeCF) and/or a sensing result calculation function (SeRF).

In the case of a UE or a 5G-RG, the UE or the 5G-RG may be included in an exemplary embodiment of the present disclosure as a UE that actually requests an ISAC service, or may be included as a UE or a 5G-RG that performs a role of a sensor for sensing a sensing object in order to provide an ISAC service through a wireless communication system.

A base station of the (R)AN constituting a wireless access network may not only transmit and receive signals for communication but may also perform an operation of sensing a sensing object as a sensor.

For quality control of an ISAC service according to an exemplary embodiment of the present disclosure, integrated sensing/communication service quality information may be used in a wireless communication system and an external ISAC service requesting device. For description of exemplary embodiments to be described later, ISAC service quality-related information may be referred to as sensing service quality (SSQ).

Referring again to FIGS. 1 and 2, a core network 200 according to an exemplary embodiment of the present disclosure may communicate with one or more entities that are connectable to a sensing device or a sensing apparatus capable of sensing a sensing object (or a target). In this case, the sensing apparatus or the sensing device may be a separate device distinct from a UE or a gNB, or may be the UE or the gNB itself.

The core network 200 may control, manage, or provide configuration information of a sensing device and configuration information of entities connected to the sensing device or entities that are the sensing device itself.

The core network 200 may receive sensing data obtained by a sensing device via entities connected to the sensing device or entities that are the sensing device itself.

Although not illustrated in FIG. 2, the core network 200 may include a sensing entity control function (SeCF), a sensing management function (SeMF), a sensing result calculation function (SeRF), and a sensing service provisioning function (SePF).

The core network 200 may provide sensing results obtained using the SeCF, the SeMF, the SeRF, and the SePF to an application.

The core network 200 may provide AI/ML, network storage, edge computing, and/or multi-access functions using the SeCF, the SeMF, the SeRF, and the SePF.

In the present disclosure, for convenience of description, a sensing entity may refer to an entity that is connected to a sensing device or is the sensing device itself and is capable of communicating with the core network 200. The sensing entity may be a device separate from the sensing device, or may be the sensing device itself having a sensing function.

The sensing entity may be an entity within a (radio) access network ((R)AN). The sensing entity may generally be a 3GPP-based or 5G/6G-based entity, or may be a non- 3GPP entity.

The sensing entity may generally be an entity within a terrestrial communication network, and may include an entity within an aerial communication network or a satellite communication network.

The sensing entity may transmit sensing information on a sensing object or a sensing target to the core network 200 (or an entity in the core network 200). In this case, when the sensing device is deployed separately from the sensing entity, sensing information of the sensing device may be delivered to the core network 200 via the sensing entity. When the sensing device has a sensing function, sensing information obtained by a sensor module in which the sensing function is implemented may be delivered to the core network 200 via a communication module of the sensing entity.

In addition, the core network 200 (or an entity in the core network 200) may control or manage a sensing process performed by the sensing entity based on the architecture shown in FIGS. 1 and 2. The sensing entity may include a UE or a gNB, and the core network 200 (or an entity in the core network 200) may control or manage the sensing entity to transmit, emit, and receive wireless signals for sensing.

The core network 200 (or an entity in the core network 200) may acquire or receive sensing information on a sensing target by cooperating with a sensing entity or using the sensing entity based on the architecture shown in FIG. 1.

A sensing entity/sensing equipment/sensing device in a 3GPP network may be a gNB or a UE. A non-3GPP sensing device may be a device using a wireless access technology not defined by 3GPP, such as Wi-Fi or Bluetooth, or may be a device such as LiDAR, laser, imaging, or a temperature sensor.

When the sensing entity is a gNB or a UE in a 3GPP network, a sensing wireless signal for a sensing target may use 5G NR and 6G wireless access technologies, but the spirit of the present disclosure is not limited by such embodiments.

The core network 200 of the embodiments in FIGS. 1 and 2 may include a sensing entity control function (SeCF), a sensing management function (SeMF), a sensing result calculation function (SeRF), and a sensing service provisioning function (SePF) as network functions related to a sensing service. These network functions may be core components for efficiently performing control, processing, calculation, and exposure of sensing data.

The SeCF may define and control configuration of sensing entities, the SeMF may collect and preprocess data, the SeRF may analyze data and generate results, and the SePF may provide results to a service. Each network function may interact through messages and procedures to integrally manage sensing data.

The SeCF may perform configuration and control of sensing entities. The SeCF may manage configurations between sensing entities and sensing equipment, and may associate and configure sensing entities and sensing equipment.

The SeMF may perform collection, adjustment, processing, and quality of service (QoS) management of sensing data. The SeMF may oversee storage and provision of sensing data.

The SeMF may instruct sensing operations to sensing entities, and may adjust and manage the sensing operations.

Roles of the serf are as follows.

Sensing result calculation: The SeRF may process sensing data by applying filtering and mapping and may derive sensing results.

Result validity verification: The SeRF may verify validity of sensing results and may manage result quality. In this case, the SeRF may evaluate and manage accuracy and response time of sensing results for quality management.

Roles of the SePF are as follows.

The SePF may manage service requests and may monitor event conditions included in the service requests.

The SePF may map sensing results according to service requests and may perform authentication and authorization for the service requests.

Service request and authentication: The SePF may manage service requests and may authenticate and authorize the service requests.

Sensing data exposure: The SePF may map service requests and sensing results and provide the same to an application service while maintaining security. The SePF may maintain security of sensing data and sensing results and may manage privacy.

The SeCF and/or the SeMF may generate a sensing trigger based on a sensing request and may deliver the sensing trigger to a non-3GPP access network or an RAN via the AMF 210.

In this case, the sensing trigger may include a request for configuration information of sensing devices and sensing entities already held by the SeCF and/or the SeMF.

In this case, a user plane function (UPF) may also deliver a portion of sensing data to the SeCF and/or the SeMF.

The SeCF and/or the SeMF may deliver sensing data to the SeRF, and the SeRF may calculate sensing results based on the sensing data and may provide the sensing results to the SeCF and/or the SeMF.

The sensing results may be delivered from the SeCF and/or the SeMF to the SePF.

The sensing results may be provided to an application side via the SePF, a sensing capability exposure function (SCEF), the NEF 230, and the AF 232.

According to an alternative exemplary embodiment of the present disclosure, the core network may further include a network data analytics function (NWDAF). The NWDAF may support AI-based analytics. The NWDAF may support preprocessing of sensing data, optimization of device configuration, and improvement of efficiency of result calculation by using AI algorithms.

The NWDAF may analyze data provided by sensing entities and may generate QoS improvement information. The QoS improvement information may be delivered to the SeCF, the SeMF, and/or the SeRF to enhance efficiency of data processing and result calculation.

A UE and a (R)AN may include sensing reference signal transmitter (Tx) and receiver (Rx) modules. The (R)AN may use various access technologies, such as Wi-Fi, New Radio (NR), E-UTRA, and 6G radio, for transmission and/or reception of sensing reference signals according to sensing policies delivered from the PCF 216.

When a UE transmits a sensing reference signal, a transmitting UE may perform transmission and/or reception of sensing reference signals according to sensing policies delivered from the PCF 216 by using various access technologies, similar to the (R)AN, with respect to a receiving UE. The (R)AN and the UE may include sensing signal analyzers/transporters. In this case, the sensing signal analyzers/transporters may directly derive meaningful results corresponding to a request by a sensing application, or may provide raw measurements to an ASP of a sensing client so that the ASP derives meanings. Sensing results may be provided directly via a user plane, or may be provided via a control plane of the core network, such as the SeCF, the SeMF, and/or the SCEF.

An application interface network function, for example, the SePF, the AF 232, the NEF 230, and/or the SCEF, may perform two roles. First, the application interface network function may convert an external request into a cellular network service request. Second, the application interface network function may store a sensing request and tag specific requirements expressed by a sensing client and deliver the same to other sensing network functions, the UDM 220, and/or the UDR 222.

Referring again to FIG. 2, the core network 200 may receive a sensing request from an application/sensing service side. In this case, a network function (NF) that performs an interface role with the application/sensing service side may include an AF 232, an NEF 230, a SePF, and/or a sensing capability exposure function (SCEF). The AF 232, the NEF 230, the SePF, and/or the SCEF may be implemented as a sensing service consumer.

For convenience of description, NFs operating as sensing service consumers will be referred to as application interface network functions.

At least one application interface network function may receive a sensing request from a sensing client and may provide sensing results obtained based on processing results in the core network 200 to the sensing client.

A UDM 220 and/or a UDR 222 may manage and store, for each UE, a set of sensing devices associated with the UE. According to an embodiment of the present disclosure, the UDM 220 and/or the UDR 222 may belong to sensing network functions or may operate in response to a request from a sensing network function.

Operations of the core network 200 may be performed by various network functions (NFs) in the core network 200 described above. These NFs may be performed by at least one entity in the core network 200, may be performed through cooperation of two or more entities, or may be performed such that individual NFs are allocated to and performed by individual entities. The spirit of the present disclosure is not limited by a hardware implementation of the NFs in the core network 200.

As shown in FIGS. 1 and 2 and FIG. 9 to be described later, a communication system according to an exemplary embodiment of the present disclosure may include at least one entity, and the at least one entity may include a memory 1200 storing at least one instruction readable in a computer and a processor 1100 executing the at least one instruction.

As shown in FIGS. 1 to 9 to be described later, in order to utilize, in a mobile communication network, various frequency bands and wireless technologies usable in a wireless device (e.g., a UE) registered with an operator of a mobile communication system and thus capable of directly using a mobile communication service, a wireless device not registered with the operator and thus incapable of directly using a mobile communication service, a mobile communication base station, and other wireless-technology access points (APs) (e.g., a Wi-Fi AP), there may be proposed a method of controlling devices having respective wireless technologies, a method of collecting wireless measurement information generated in multiple bands to recognize a state of an object, and a system architecture therefor.

According to embodiments of the present disclosure, it may be possible to measure object state information by controlling wireless technologies and frequency bands other than mobile communication frequencies, and through this, it may be possible to increase accuracy of recognizing object states through a mobile communication system.

The present disclosure proposes a comprehensive solution for implementing a sensing service through a cellular system by using various wireless communication signals of various technologies, such as Wi-Fi, LTE, NR, Bluetooth, and UWB.

As shown in FIGS. 1 and 2, an architecture designed to facilitate control over various frequency bands and wireless technologies (including devices not based on a USIM and technologies not defined by 3GPP) is illustrated.

The present disclosure may propose a framework that enables interaction between a mobile communication operator and devices not subscribed to a cellular system. As shown in FIGS. 1 and 2, interaction between a cellular network and an ASP may be defined.

FIGS. 1 and 2 illustrate an example of a cellular system architecture designed to discover and/or recognize and control sensing devices that are not capable of communicating through standard cellular frequency bands and technologies.

Each first user equipment (UE) may be associated with a set of first sensing devices, and the set may also include a first object sensed through a device in the set or through the UE. For example, in FIG. 1, a set associated with UE “B” 130 may include sensing devices 151, 154, and 155 and an object 160 that may be sensed through the sensing devices. The cellular core network 200 may store, in a network function such as the UDM 220 and the UDR 222, set information for each UE.

UE “A” 110 may be associated with sensing devices 151, 152, and 153, and these sensing devices may be included in a management framework of the core network 200 through non-3GPP access. In this case, the core network 200 may access the set of sensing devices associated with UE “A” 110 via a non-3GPP interworking function (N3IWF) or a 5G-RG. The N3IWF may serve as a gateway for accessing a 5G core network 200 through a non- 3GPP network (e.g., Wi-Fi) in the 5G core network 200, and the 5G-RG may serve as a gateway for accessing the 5G core network 200 through residential access in the 5G core network 200. In the present disclosure, a detailed description of operations of the N3IWF and the 5G-RG is omitted.

When there is a sensing request for a target object 160, a sensing device 151 closest to the target object 160 may generate sensing information on the object 160. In this case, the sensing device 151 may be managed as being included in a device set of UE “B” 130 via an RAN. In this case, UE “B” 130 may be designated as an associated UE of the target object 160 and the sensing device 151. In this case, information on the target object 160, the sensing device 151 participating in sensing, and the associated UE “B” 130 may be generated as set information and may be stored in the UDM 220 or the UDR 222 in the core network 200.

When UE “B” 130 moves away from the sensing device 151, mobility information of UE “B” 130 may be updated, and the core network 200 may newly designate UE “A” 110 as an associated UE participating in sensing for the target object 160. In this case, information on the target object 160, the sensing device 151 participating in sensing, and the associated UE “A” 110 may be stored in the UDM 220 or the UDR 222 in the core network 200 as new or updated set information.

Alternatively, even when the object 160 moves away from the sensing device 151 and becomes close to the sensing device 153, mobility information of UE “B” 130 and UE “A” 110 may be updated, and the core network 200 may newly designate the sensing device 153 participating in sensing for the target object 160 and UE “A” 110 as an associated UE.

Since such mobility may be possessed by each of a UE, a sensing device, and an object, even when a sensing device moves, mobility information of a UE may be updated, and the core network 200 may designate a new sensing device and an associated UE participating in sensing for the target object 160 and may update related set information.

A sensing device may communicate with a UE through a wireless channel and may have one or more sensing capabilities corresponding to the relevant technology. The present disclosure may consider a case where a sensing device is not capable of directly interacting with a cellular network. For example, the sensing device may include non-subscribers and devices not capable of using cellular frequencies and technologies.

Due to limited communication capability of a sensing device, an associated UE in a set may serve as a mediator so that a cellular network system controls sensing in the device. In this case, a condition that the UE is capable of establishing a data communication link with the sensing device may be assumed.

When the cellular network system determines to trigger sensing using a device, the cellular network system may identify an associated UE for the device through the UDM 220 and the UDR 222, and may transmit a signal or a UE policy/configuration update to activate sensing.

When the UE receives the signal, the UE may activate sensing in the sensing device through a direct communication channel according to instructions of the cellular network and/or configured information of a sensing application implemented in a UE app.

An object sensed or to be sensed through the UE may be registered in the UDM 220 and the UDR 222 as a portion of a UE set. When a sensing device or a UE in a set detects an object, the UE may register the detected object in the UDM 220 and the UDR 222 as an element of the UE's set. When sensing is re-requested for monitoring the detected object, the cellular network may recognize a location of the object and a reachable UE based on pre-registered set information.

Since an object, a sensing device, and a UE may have mobility, the UE may dynamically update set information (e.g., set elements) thereof in the cellular network. Due to mobility and a possibility of loss of a communication channel, a set does not guarantee a state of a UE. When the cellular network fails to activate a sensing device or an object in a set or to find a location thereof via a UE, the cellular network may update set elements in the UDM 220 and the UDR 222 and may remove a failed device or object from the set.

A sensing service consumer NF may include the AF 232 and the NEF 230. In addition, an SCEF or a SePF, etc. not illustrated may be included in sensing service consumer network functions.

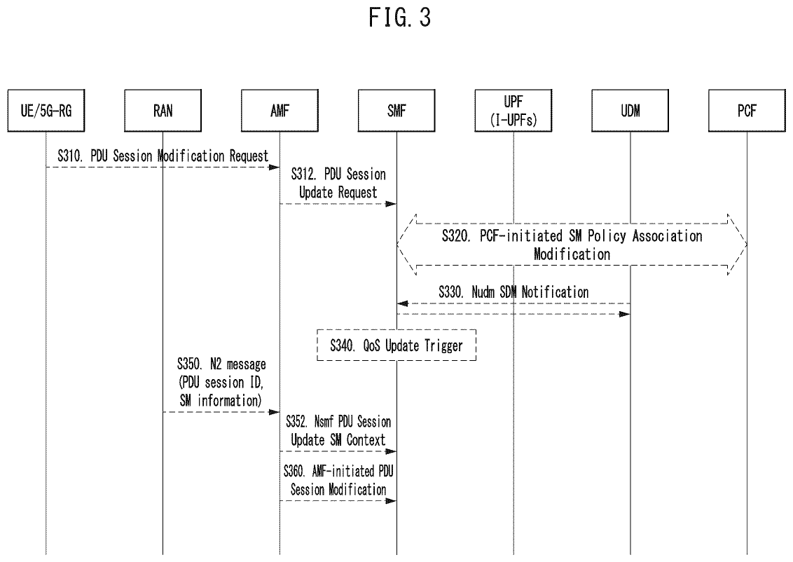

As shown in FIGS. 3 to 6, operation flow diagrams illustrate processes among an associated UE or a 5G-RG associated with a non-3GPP device, an (R)AN, and a plurality of network functions in a core network for a session management method according to an exemplary embodiment of the present disclosure.

As shown in FIG. 3, a UE or a 5G-RG (illustrated as a UE in the drawing) may initiate a PDU session modification procedure by transmitting a NAS (Non-Access Stratum) message (S310). In this case, the NAS message may include an N1 session management (SM) container (including a PDU session modification request (PDU session ID, packet filter, operation, requested QoS, segregation, 5GSM core network function, number of packet filters, URSP rule enforcement report, requested always-on PDU session, requested non-3GPP delay budget, and non-3GPP device connection information)), a PDU session ID, a UE integrity protection maximum data rate, and a port management information container.

Operation S310 may be performed using a NAS (Non-Access Stratum) message or an N1 message transmitted between the UE or the 5G-RG and an AMF. In particular, in the present disclosure, a message format for establishing and managing a PDU (Protocol Data Unit) session for data communication may be used. In this case, non-3GPP device connection information recognized by the UE or the 5G-RG may be shared between the UE and the core network (in particular, the AMF) using the N1 message.

A NAS-SM (Non-Access Stratum-Session Management) indication may refer to a signal indicating an intention of the UE to transmit a NAS message for session management to a core network. When the AMF receives the NAS-SM indication from the UE, the AMF may forward a NAS-SM message to an SMF, and the core network may prepare for message transmission and reception with the UE for session management. Message exchanges for modifying a PDU session may follow after reception of the NAS-SM message.

Depending on an access type, when the UE is disconnected from the AMF of the core network and is in a CM-IDLE state in which power consumption is minimized, an SM-NAS message may be executed prior to a service request procedure. The NAS message may be delivered to the AMF together with user location information by an (R)AN. In operation S312, the AMF may transfer the PDU session modification request of the UE to the SMF using an Nsmf_PDUSession_UpdateSMContext (which may include an SM context ID and an N1 SM container including a PDU session modification request).

In operations S310 and S312, when the UE requests specific QoS handling for a selected service data flow (Service Data Flow, SDF), the PDU session modification request may include a packet filter describing the SDF, a requested packet filter operation (add, modify, delete) for the indicated packet filter, and requested QoS, and may optionally include a segregation indication.

A segregation indication may be included when the UE recommends that an applicable SDF be bound to a separate dedicated QoS flow. The segregation indication may also be included even when an existing QoS flow is capable of supporting the requested QoS. While the network may follow the request of the UE, binding the selected SDF to an existing QoS flow may be allowed.

For traffic segregation, a single QoS flow may be used. When the UE requests additional SDF segregation, an additional SDF may be multiplexed onto an existing QoS flow used for segregation.

When the UE is outside an available area of a local area data network (Local Area Data Network, LADN), the UE may not trigger a PDU session modification procedure for a PDU session corresponding to the LADN.

When a PS Data Off status changes, the changed status may be included in protocol configuration options (PCO) of a PDU session modification request message.

When the UE supports traffic identification for a connected non-3GPP device and/or determines that QoS differentiation for the connected non-3GPP device is required, the UE may include, in non-3GPP device connection information in the PDU session modification request, a non-3GPP device identifier and a user plane address associated with the non-3GPP device.

The UE may determine whether QoS differentiation is required based on specifications requested by an application.

In operation S312, the AMF may use an Nsmf_PDUSession_UpdateSMContext (SM context ID, N1 SM information) procedure. Using the procedure, the AMF may transmit the NAS-SM message received from the UE or the 5G-RG through operation S310, in particular the N1 session management (SM) container, to the SMF, and at this time, non-3GPP device connection information recognized by the UE or the 5G-RG may be shared between the UE and the core network (in particular, the SMF) using the N1 message.

In operation S320, the PCF may notify the SMF of policy modifications by performing a session management (SM) policy association modification procedure initiated by the PCF. The procedure may be triggered, for example, by a policy decision or an AF request (such as traffic routing influence of an application function or a case in which the AF provides port management information in a container).

In operation S320, when QoS monitoring is requested by the AF, the PCF may generate a QoS monitoring policy for the corresponding service data flow and provide a policy within PCC rules to the SMF.

In operation S320, the PCF may provide PDU set control information and protocol descriptions within PCC rules based on information provided by the AF and/or a local operator policy.

In operation S330, the UDM may update subscription data of the SMF through Nudm_SDM_Notification (SUPI, session management subscription data). The SMF may update the session management subscription data and respond to the UDM by returning an acknowledgment including a SUPI. Subscriber Data Management (SDM) may refer to a solution or a network function for centrally managing all data such as a subscriber profile, authentication information, and service subscription configuration in a communication network.

In operation S340, the SMF may determine to modify a PDU session. The PDU session modification may be triggered according to a locally configured policy or may be triggered by an (R)AN. The PDU session modification may also be triggered when a user plane (UP) connection is activated (as described in a service request procedure) and/or when the SMF indicates that one or more QoS flow states have been removed in a 5GC but have not yet been synchronized with the UE.

The PDU session modification may also be triggered to update a QoS profile of an NG RAN and a PDU set information indication of a PSA UPF after completion of a mobility procedure.

The SMF may perform operation S340 in consideration of PDU session information affected by non-3GPP device connection information, or when a request for PDU session modification is triggered by operations of operations S310 to S330 described above. Operation S340 may also be performed by a decision of the SMF itself when predetermined conditions are satisfied (for example, reception of non-3GPP device connection information).

The PDU session modification may be triggered to share updated non-3GPP device connection information used in a PDU session within the core network, or to notify the UE of updated information. For example, the PDU session modification may be triggered based on updated ECS address configuration information, updated DNS server addresses, an EAS rediscovery indication, non-3GPP device connection information, or the like.

Operation S340 may include a trigger for QoS update.

In operation S350, an (R)AN-initiated modification may be triggered.

In operation S350, when AN resources to which QoS flows are mapped are released, the (R)AN may notify the SMF of the release regardless of whether notification control is configured. The (R)AN may transmit an N2 message (PDU session ID, N2 SM information) to the AMF.

Operation S350 may be performed using an N2 message format, which is a control plane signaling message exchanged between an NG-RAN (gNB) and an AMF (Access and Mobility Management Function). In particular, in the present disclosure, procedures for exchanging information required to establish, modify, or release a data session between a UE and a core network (session management), or for synchronizing various contexts such as a UE connection state, location, and configuration information between the AMF and the RAN (UE context management), may be used. For example, a PDU Session Resource Setup Request message by which a UE requests establishment of a PDU session for data communication and/or a UE Context Release transmitted from the AMF to the RAN when the UE disconnects from the network may be used.

Non-3GPP device connection information recognized by the (R)AN may be shared between the (R)AN and the core network (in particular, the AMF) using the N2 message.

The N2 SM information may include a QFI, user location information, and information indicating that a QoS flow has been released.

In operation S352, the AMF may invoke and use an Nsmf_PDUSession_UpdateSMContext (SM context ID, N2 SM information) procedure. Using the procedure, the AMF may transmit a NAS-SM message received from the (R)AN through operation S350, in particular an N2 session management (SM) container, to the SMF, and at this time, non-3GPP device connection information recognized by the (R)AN may be shared between the (R)AN and the core network (in particular, the SMF) using the N2 message.

In an alternative embodiment of operation S350, when notification control is configured for a GBR QoS flow, the (R)AN may transmit an N2 message (PDU session ID, N2 SM information) to the SMF when it determines that a QoS objective of the QoS flow cannot be satisfied or can be satisfied again. The N2 SM information may include a QFI and an indication that the QoS objective of the corresponding QoS flow cannot be satisfied or can be satisfied again.

When the QoS objective cannot be satisfied, the N2 SM information may indicate a reference to an alternative QoS profile that matches QoS parameter values currently satisfied by the NG-RAN.

In operation S352, the AMF may use an Nsmf_PDUSession_UpdateSMContext (SM context ID, N2 SM information) procedure. When the PCF subscribes to the corresponding event, the SMF may report a subscribed event to the PCF for each PCC rule for which notification control is configured in operation S410 described later.

In operation S360, an AMF-initiated PDU session modification may be performed. In operation S360, the AMF may trigger a PDU session modification to the SMF providing the PDU session of the UE. In operation S360, the PDU session modification may be triggered based on related/connection information of a non-3GPP device associated with the UE.

Operation S360 may be implemented in various embodiments as follows.

When the UE supports Coverage Enhancement (CE) mode B and use of CE mode changes from restricted to unrestricted or from unrestricted to restricted in Enhanced Coverage Restriction information in a UE context of the AMF while the UE has already established a PDU session, the AMF may trigger a PDU session modification to the SMF providing the PDU session of the UE.

When the AMF determines that a Non-Access Stratum Session Management (NAS-SM) timer needs to be updated due to a change in Enhanced Coverage Restriction, the AMF may trigger a PDU session modification to the SMF providing the PDU session of the UE.

Alternatively, when use of CE mode B is unrestricted in Enhanced Coverage Restriction information in the UE context of the AMF, the AMF may trigger a PDU session modification to include an extended NAS-SM indication in the PDU session.

When the AMF is aware, based on preconfigured configuration information, that the UE accesses through a gNB using a GEO satellite backhaul and that a GEO satellite ID needs to be updated to the SMF, the AMF may include an updated GEO satellite ID based on the preconfigured configuration.

As an alternative embodiment of operation S360, the AMF may notify the SMF of an NWDAF ID used for UE-related analytics and an update of the corresponding analytics ID. In addition, when the PCF requests an SM policy association notification and there is a PDU session configured for a corresponding DNN, the AMF may transmit S-NSSAI [PCF binding information, SM policy association notification configuration].

As another alternative embodiment of operation S360, when the AMF determines that an S-NSSAI (Single-Network Slice Selection Assistance Information) is to be replaced with an alternative S-NSSAI, the AMF may use an Nsmf_PDUSession_UpdateSMContext request (SM context ID, S-NSSAI, alternative S-NSSAI) transmitted to the SMF of the PDU session associated with the S-NSSAI.

As another alternative embodiment of operation S360, when the AMF determines that an S-NSSAI is in an area restriction state (for example, when the S-NSSAI is configured as NS-AoS or the S-NSSAI exists in a Partially Allowed NSSAI), the AMF may invoke an Nsmf_PDUSession_UpdateSMContext request (SM context ID, S-NSSAI, slice area restriction indication) to notify the SMF that the PDU session is subject to area restriction for the S-NSSAI. When the S-NSSAI is replaced with an alternative S-NSSAI, the AMF may only check area restriction for the alternative S-NSSAI for the PDU session.

Based on an extended NAS-SM timer indication, the SMF may use an extended NAS-SM timer setting for the UE.

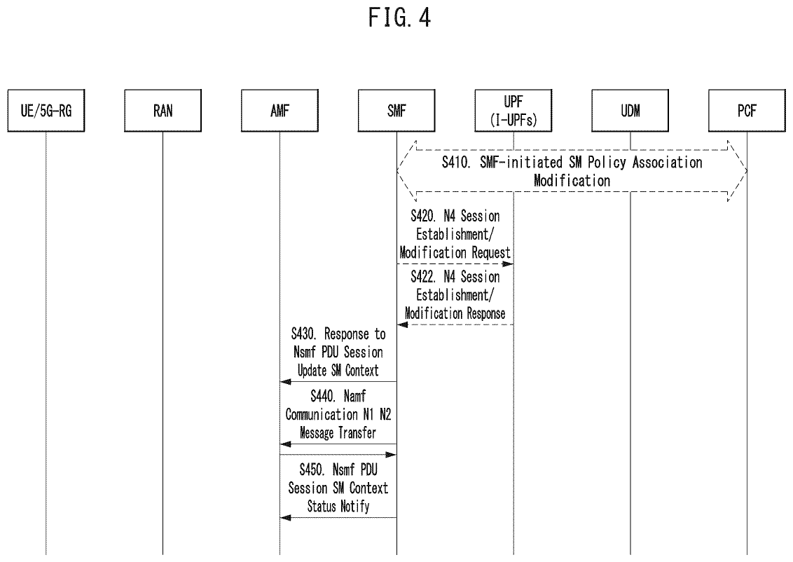

Operations S310 to S360 illustrated in FIG. 3 may be performed independently or may be performed in association with one another. For example, in one embodiment, after operations S310 and S312 are performed, operation S410 of FIG. 4 described later may be performed. In another alternative embodiment, after operation S320 or operation S340 is performed, operation S410 of FIG. 4 may be performed.

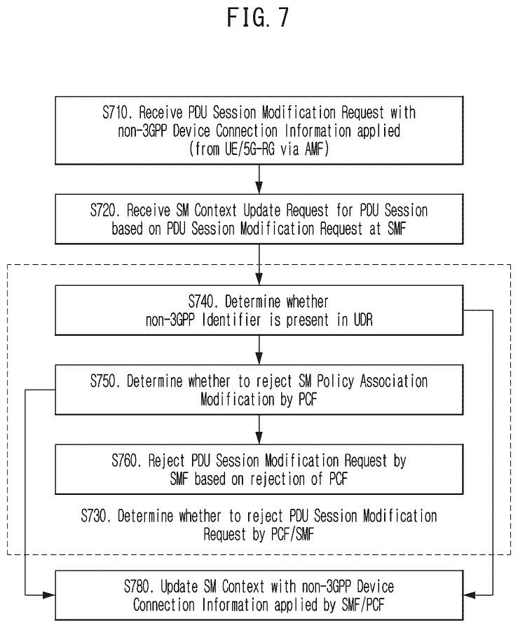

In an exemplary embodiment of the present disclosure, after at least one of operations illustrated in FIG. 3 is performed and before operation S410 is performed, whether to reject a PDU session modification request may be determined by a PCF and/or an SMF, as illustrated as part of FIG. 7 (S730, S740, S750, and S760).

As shown in FIG. 4, each operation may be performed including parameters associated with a PDU session modification procedure that is affected by related/connection information of a non-3GPP device recognized by and associated with the UE or the 5G-RG.

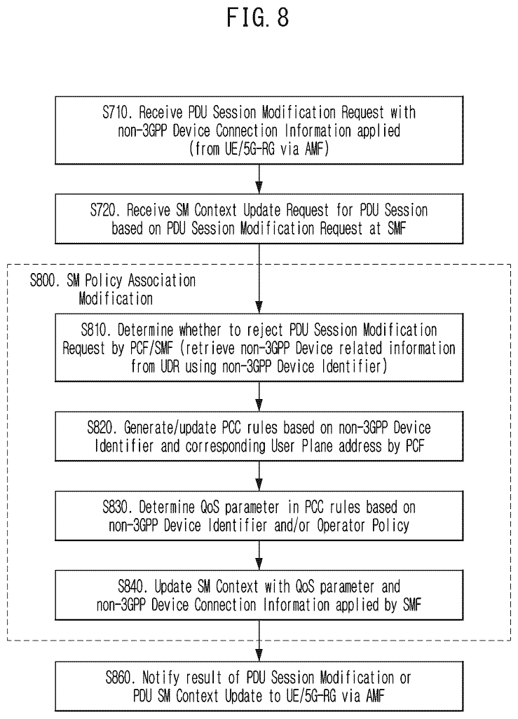

In operation S410, the SMF may be required to request the PCF to report subscription events for policy modification by performing an SM policy association modification procedure initiated by the SMF. Specifically, in operation S410, the SMF may request an Npcf_SMPolicyControl_Update procedure to receive a policy decision (re-)request from the PCF and a result thereof. In particular, using the procedure, non-3GPP device connection information or identifiers recognized by the UE, the 5G-RG, or the (R)AN and received by the SMF through operation S312 or operation S352 may be delivered to the PCF, and the SMF may request a policy decision related to each non-3GPP device from the PCF. When the PCF receives non-3GPP device connection information or an identifier from the SMF through the procedure, the PCF may check whether non-3GPP device connection information (for example, QoS information) for the non-3GPP device identifier exists in the PCF, and when the information does not exist, the PCF may request a Nudr_DM_Query procedure to the UDR to receive non-3GPP device identifier information for the non-3GPP device identifier. Through this, authentication and policy decisions such as QoS for the requested non-3GPP device identifier may be performed, and detailed operations are disclosed as part of FIG. 8 described later. When the PCF fails to find non-3GPP device identifier information (for example, a non-3GPP device identifier and applicable QoS) from the UDR or when the information does not exist within the PCF, the PCF may reject a policy decision for the requested non-3GPP device. When a PDU session modification procedure is triggered in operation S320 or operation S340 described above, this operation may be omitted. When dynamic PCC is not deployed, the SMF may apply a local policy to determine whether to modify a QoS profile.

The PCF may generate an SDF template in PCC rules based on reported connectivity capabilities.

When only operations at a UPF (for example, gating) are required for PDU session modification, operations S420 to S450 and operations S510 to S542 described later may be omitted.

In operations S420 and S422, the SMF may update the UPF with N4 rules related to a new QoS flow or a modified QoS flow. In operation S420, the SMF may transmit an N4 session establishment/modification request including UL packets including a QFI of the new QoS flow or the modified QoS flow to the UPF.

Operations S420 and S422 may be performed using an N4 message format, which is a message used for control plane communication between the SMF and the UPF. The N4 interface may be utilized based on a Packet Forwarding Control Protocol (PFCP). In the present disclosure, message types for establishment, modification, and deletion of a PDU session may be utilized. Non-3GPP device connection information recognized by the UE and/or the 5G-RG and/or the (R)AN and policies updated through the procedure of operation S410 may be shared between the SMF and the UPF using the N4 message.

The following content may be updated and applied based on communication between the SMF and the UPF when there is a need to update, by related/connection information of a non-3GPP device recognized by a UE or a 5G-RG and associated with the UE or the 5G-RG.

When the SMF starts a PDU session modification procedure in operation S320 based on a PCF-initiated SM Policy Association Modification in which one or more PCC rules are added together with a TSC assistance container, and/or when interaction with a TSN deployed in a transport network is supported, the SMF may instruct the UPF to assign or remove a separate N3 tunnel endpoint address for an assigned QoS flow together with the TSC assistance container.

When the SMF starts a PDU session modification procedure in operation S340 by receiving a status group from a TN CNC, the SMF may include, in an N4 session modification request transmitted to the UPF, a TL container including a set-request.

When the SMF starts a PDU session modification procedure in operation S320 based on a PCF-initiated SM Policy Association Modification in which one or more PCC rules including an UL and/or DL periodicity are added, the SMF may configure TSCAI using periodicity information.

When the SMF starts a PDU session modification procedure in operation S320 based on a PCF-initiated SM Policy Association Modification, one or more PCC rules for instructing N6 traffic parameter measurements (for example, an N6 jitter range associated with a DL periodicity and an UL/DL periodicity) are added to an SM Policy Association Modification, and thus the SMF may instruct the UPF to perform N6 traffic parameter measurements associated with a DL periodicity for a QoS flow. An N6 interface may refer to an interface connecting a user plane function (UPF) and an external data network (DN).

When N6 traffic parameter measurement is requested and a DL periodicity is received in a PCC rule, the SMF may include, in a request to the UPF, the DL periodicity and an N6 traffic parameter measurement indication.

When a PCC rule includes a protocol description for DL and PDU set QoS parameters and the SMF determines to activate PDU set identification and indication for PDU set based processing by a PSA UPF, the SMF may be required to provide protocol description information and a PDU set indication to the UPF and to request the UPF to indicate PDU set information in each PDU belonging to a PDU set.

When the SMF determines to activate an End of Data Burst indication through the PSA UPF, the SMF may be required to request the UPF to indicate End of Data Burst. When a PCC rule includes a protocol description, the SMF may be required to provide protocol description information to the UPF.

When PDU set information indication is activated at the UPF for a QoS flow, the SMF may request the UPF to stop PDU set information indication based on an indication from the RAN or the PCF. For example, a case in which a target RAN does not support PDU set based processing may be included in this case.

Based on a PCF-initiated SM Policy Association Modification in which one or more PCC rules are added together with PDU set control information, the SMF may perform PDU set based QoS handling.

When redundant transmission for a PDU session is not activated and the SMF determines to perform redundant transmission for a QoS flow, the SMF may instruct the UPF to perform packet duplication and elimination for the QoS flow.

When redundant transmission is activated in a PDU session and the SMF determines to stop redundant transmission, the SMF may instruct the UPF to release CN tunnel information used as a redundant tunnel of the PDU session, and may also instruct the UPF to stop packet duplication and elimination for the corresponding QoS flow.

The SMF may utilize redundant transmission experience analytics provided by an NWDAF when determining whether to perform redundant transmission or, when redundant transmission is activated, whether to stop redundant transmission.

When the AMF starts a PDU session modification procedure in operation S360 by replacing a network slice with an alternative S-NSSAI and the SMF determines that the PDU session is maintained, the SMF may transmit an N4 session modification request message to the UPF to replace an S-NSSAI with the alternative S-NSSAI.

In operation S422, the UPF may respond to the SMF. When redundant transmission for a PDU session is not activated and the SMF indicates, in operation S420, the UPF to perform packet duplication and elimination for a QoS flow, the UPF may allocate additional CN tunnel information. The additional CN tunnel information may be provided to the SMF.

When redundant transmission for a PDU session is not activated and the SMF determines, in operation S420, to perform redundant transmission for a QoS flow using two I-UPFs, the UPF may allocate CN tunnel information. CN tunnel information of each I-UPF may be provided to the SMF (S422).

When interaction with a TSN deployed in a transport network is supported, the UPF supports CN-TL, and the UPF/CN-TL receives a TL-Container including a set-request from the SMF/CUC in operation S420, the UPF/CN-TL may include, in an N4 session modification response, a TL-Container including a set-response (S422).

When requested by the SMF in operation S420, the PSA UPF may start N4 session level reporting for an N6 traffic parameter measurement report (S422). When N6 traffic parameters are available, a response to the SMF in this operation may include N6 traffic parameters (for example, an N6 jitter range associated with a DL periodicity and an UL/DL periodicity) for a QoS flow. The SMF may configure TSCAI with the received N6 traffic parameters.

In operation S430, in a case of a modification initiated by a UE or an (R)AN (S350 and S352) or a modification initiated by the AMF (S360), the SMF may respond to a request from the AMF using an Nsmf_PDUSession_UpdateSMContext response ([N2 SM information (PDU session ID, QFI, QoS profile, [alternative QoS profile], session-AMBR], [CN tunnel information]), N1 SM container (PDU session modification command (PDU session ID, QoS rules and associated UL protocol description (when available), QoS rule operation, QoS flow level QoS parameters when required for a QoS flow associated with a QoS rule, session-AMBR, [always-on PDU Session Granted], [port management information container], [non-3GPP QoS support information container], [non-3GPP device identifier]))).

When a UE requests a PDU Session Modification to modify a PDU session to an always-on PDU session, the SMF may notify whether to change the PDU session to an always-on PDU session through an always-on PDU session granted indication of the PDU session modification command by including an always-on PDU session granted indication in the PDU session modification command.

The N2 SM information includes information that the AMF is to provide to the (R)AN. The N2 SM information may include a QoS profile and a corresponding QFI to inform the (R)AN that one or more QoS flows are added or modified. Alternatively, the N2 SM information may include only a QFI to inform the (R)AN that one or more QoS flows are removed.

The SMF may indicate whether to perform redundant transmission through a redundant transmission indicator for each QoS flow. When the SMF determines to activate redundant transmission in operation S420, the SMF may include assigned additional CN tunnel information in the N2 SM information. When the SMF determines to perform redundant transmission for a new QoS flow using two I-UPFs in operation S420, the SMF may include CN tunnel information assigned for the two I-UPFs in the N2 SM information.

When a PDU session modification is triggered due to an (R)AN release in operation S352, the N2 SM information may include an acknowledgement for the (R)AN release. When a UE requests a PDU session modification for a PDU session for which user plane resources are not established, the N2 SM information provided to the (R)AN may include information for user plane resource setup. In a case of network slice replacement, when the SMF determines that the PDU session is to be maintained, S-NSSAI of the N2 SM information may be set to an alternative S-NSSAI.

When the SMF receives a requested non-3GPP Delay Budget for a QoS flow from a PEGC, the SMF may adjust a dynamic CN PDB (packet delay budget, Packet Delay Budget, which may refer to an upper limit of time for which a packet is delayed between a terminal and a UPF) delivered to an NG-RAN.

When redundant transmission is activated in a PDU session and the SMF determines, in operation S420, to stop redundant transmission, the SMF may instruct the (R)AN to release an AN tunnel and to stop packet duplication and elimination related to a redundant tunnel of the PDU session.

The N1 SM container may include a PDU session modification command that the AMF is to provide to a UE. The PDU session modification command may include QoS rules and an associated UL protocol description (when available), QoS flow level QoS parameters for a QoS flow associated with a QoS rule when required, and an operation of the corresponding QoS rule, and may also include an operation of QoS flow level QoS parameters for informing the UE that one or more QoS rules are added, removed, or modified.

When the PCF provides a PCC rule together with a protocol description for UL based on an operator policy in operation S410, the SMF may additionally provide the protocol description for UL together with associated QoS rules.

When the AMF starts a PDU session modification procedure in operation S360 due to network slice replacement and the SMF determines that the PDU session is to be maintained, the SMF may include an alternative S-NSSAI in a PDU session modification command for the UE and may include a cause value indicating that S-NSSAI of the PDU session is replaced with the alternative S-NSSAI.

When the AMF starts a PDU session modification procedure in operation S360 due to network slice replacement, the PDU session is SSC mode 3 (a mode in which, when a user moves, an existing session is not released and a new IP address is allocated through a new UPF (User Plane Function) to maintain a connection), and the SMF determines that the PDU session is to be re-established in an alternative S-NSSAI, the SMF may include an alternative S-NSSAI in a PDU session modification command for the UE and may include a cause value indicating that the PDU session is to be re-established in the alternative S-NSSAI.

A UE may re-establish a new PDU session in an alternative S-NSSAI. When the PDU session is SSC mode 1 (a mode in which, when a user moves, a session connection is maintained and an IP address is not changed) or SSC mode 2 (a mode in which, when a user moves and a session is disconnected, an existing PDU session is terminated and a new PDU session is created), the SMF may initiate PDU session release.

When the SMF receives a port number and a port management information container from the PCF in operation S410, and the port number matches a port number allocated to a DS-TT port of this PDU session, the SMF may include the port management information container in the N1 SM container.

After receiving QoS notification control, the SMF may be required, to inform the UE of changes in QoS parameters (for example, 5QI, GFBR, MFBR) that an NG-RAN is currently fulfilling, to transparently transfer a PDU session modification command through the NG-RAN. When the SMF transparently transfers the PDU session modification command through the NG-RAN, the N2 SM information may not be included as a part of Namf_Communication_N1N2MessageTransfer of operation S440 described later.

When a UE indicates, in a PCO, that the UE supports an EDC function, the SMF may indicate to the UE that use of the EDC function is allowed for a PDU session or that use of the EDC function is required for the PDU session.

Based on S-NSSAI and a DNN for a PIN, the SMF may provide, in an N1 SM container, non-3GPP QoS support information per QoS flow to a UE.

When the SMF receives a non-3GPP device identifier in operation S312, the SMF may provide, in an N1 SM container, an allowed non-3GPP device identifier or a rejected non-3GPP device identifier to a UE in detail as a policy decision result for a non-3GPP device determined through operation S410, or may provide the result briefly as approval or rejection for a PDU session modification request, and, in a case of rejection, together with a reason for the rejection (for example, that a requested non-3GPP identifier is not available in a network).

When the SMF receives an indication that a PDU session is subject to application of area restriction for an S-NSSAI and the SMF has not previously subscribed to an event, the SMF may subscribe to a “UE mobility event notification” event for reporting existence of a UE in an area of interest by providing the S-NSSAI as an indicator for the area of interest.

When the SMF does not receive an indication that a PDU session is subject to area restriction for an S-NSSAI, and the SMF has previously subscribed to a “UE mobility event notification” event in an AMF, the SMF may cancel subscription to the “UE mobility event notification” event in the AMF.

In operation S440, for a modification requested by the SMF, the SMF may call and use Namf_Communication_N1N2MessageTransfer ([N2 SM information] (PDU session ID, QFI, QoS profile, [alternative QoS profile], session-AMBR, [CN tunnel information], QoS monitoring indication, QoS monitoring reporting frequency, QoS monitoring parameters), [TSCAI], TL-Container, [ECN marking for an L4S indicator]), N1 SM container (PDU session modification command (PDU session ID, QoS rules and associated UL protocol description (when available), QoS flow level QoS parameters for a QoS flow associated with a QoS rule when required, QoS rule operation and QoS flow level QoS parameter operation, session-AMBR))).

Operation S440 may be performed based on an ‘N1N2MessageTransfer’ service operation used for an AMF to transfer N1 or N2 information received from another network function (NF) to a UE or a 5G-RAN.

When the SMF starts a PDU session modification procedure (S410) based on a PCF initiated SM Policy Association Modification (S320) in which one or more PCC rules are added together with a TSC assistance container, and/or when interaction with a TSN deployed in a transport network is supported, the SMF may instruct an NG-RAN to assign or remove a separate N3 tunnel endpoint address for a QoS flow assigned together with the TSC assistance container.

The SMF may indicate whether to perform redundant transmission through a redundant transmission indicator for each QoS flow (S440). When the SMF determines to activate redundant transmission in operation S420, the SMF may include assigned additional CN tunnel information in the N2 SM information. When the SMF determines to perform redundant transmission for a new QoS flow using two I-UPFs in operation S420, the SMF may include CN tunnel information assigned for the two I-UPFs in the N2 SM information.

When redundant transmission is activated in a PDU session and the SMF determines, in operation S420, to stop redundant transmission, the SMF may instruct the (R)AN to release an AN tunnel and to stop packet duplication and elimination related to a redundant tunnel of the PDU session.

The SMF may indicate a QoS monitoring request for a QoS flow according to information received from the PCF in operation S320 or an SMF local policy (for example, when an RAN rejects creation of a specific QoS flow) (S440). When receiving the QoS monitoring request, an RAN may activate an RAN part of UL/DL packet delay measurement for a QoS flow, and the RAN may determine a packet delay measurement frequency of the RAN part using a QoS monitoring reporting frequency.

When receiving a congestion information request, an RAN may start UL and/or DL QoS flow congestion information reporting to a PSA UPF.

When an SMF starts a PDU session modification procedure in operation S340 by receiving a status group from a TN CNC, the SMF may perform operation S440 by including, in N2 SM information, a TL container including a set-request.

When a UE is in a CM-IDLE state and ATC is activated, an AMF may update and store a UE context based on Namf_Communication_N1N2MessageTransfer, and operations S510, S520, S530, S540, and S542 may be omitted. When the UE is reachable, that is, when the UE transitions to a CM-CONNECTED state, the AMF may synchronize the UE context with the UE by transferring an N1 message.

When a PCF provides a PCC rule together with a protocol description for UL based on an operator policy in operation S410, an SMF may provide the protocol description for UL together with an associated QoS rule (S440).

In operation S450, when a modification request occurs in an SMF due to SMF-related parameters updated in a UDM, the SMF may provide, to an AMF, CN-supported RAN parameter tuning information derived from the SMF. The SMF may call Nsmf_PDUSession_SMContextStatusNotify (CN-supported RAN parameter tuning information derived from the SMF) toward the AMF. The AMF may store the CN-supported RAN parameter tuning information derived from the SMF in a relevant PDU session context of a corresponding UE.

In an alternative exemplary embodiment of S450, when a modification request occurs in an SMF due to an updated NWDAF ID, the SMF may notify, to an AMF, an NWDAF ID used for UE-related analytics and an update of a corresponding analytics ID.

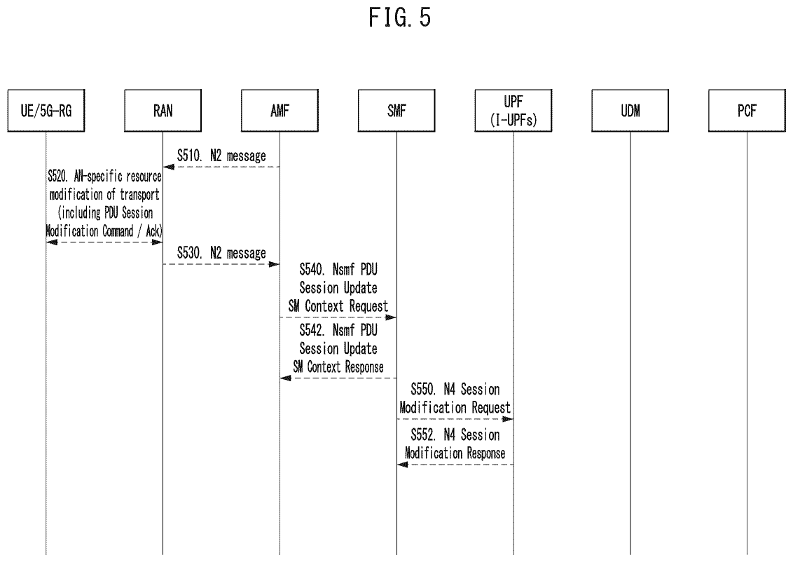

As shown in FIG. 5, each operation may be performed including parameters associated with a PDU session modification procedure affected by related/connection information of a non-3GPP device that is recognized by a UE and associated with the UE.

In operation S510, an AMF may transmit, to an (R)AN, an N2 ([N2 SM information received from an SMF], NAS message (PDU session ID, N1 SM container (PDU session modification command))) message.

In operation S510, as a response to a PDU session modification request or a request to update a PDU session management context, an N2 message in which an approval/rejection result of a PDU session modification request by a PCF and/or an SMF is loaded in an N1 SM container may be delivered, via the AMF, to a user equipment (UE) or a 5G residential gateway (5G-RG).

An approval/rejection process of a PDU session modification request by a PCF and/or an SMF is disclosed as a part of FIG. 7 described later.

An N2 message transmitted in operation S510 may include an approval/rejection result and, in a case of rejection, a reason for the rejection (for example, that a requested non-3GPP identifier is not available in a network).

When a non-3GPP device identifier is included in an N2 SM container, an (R)AN may compare a non-3GPP device identifier transmitted in operation S350 with the non-3GPP device identifier of the N2 SM container to determine a non-3GPP device identifier that is not provisioned in the (R)AN. For a non-provisioned non-3GPP device identifier, the (R)AN may modify or delete a configuration for the corresponding non-3GPP identifier, or may request, through an application or OAM, provisioning of the corresponding non-3GPP identifier and non-3GPP identifier information in a 5G core network, and may not attempt PDU session modification until the corresponding identifier is re-provisioned in the 5G core network.

In operation S520, an (R)AN may perform, with a UE, AN-specific signaling exchange related to information received from an SMF. For example, in a case of an NG-RAN, an RRC connection reconfiguration for a UE to modify required (R)AN resources related to a PDU session may be performed. Alternatively, when receiving only an N1 SM container from an AMF in operation S510, an RAN may transmit only the corresponding N1 SM container to a UE.

An (R)AN may reconfigure AS parameters by considering updated CN-assisted RAN parameter tuning. In this case, an N1 SM container may be provided to a UE. When a port management information container (Port Management Information Container) is included in an N1 SM container, a UE may provide the corresponding container to a DS-TT.

When a non-3GPP device identifier is included in an N1 SM container, a UE or a 5G-RG may compare a non-3GPP device identifier transmitted in operation S310 with the non-3GPP device identifier of the N1 SM container to determine a non-3GPP device identifier that is not provisioned in the UE or the 5G-RG. For a non-provisioned non-3GPP device identifier, the UE or the 5G-RG may modify or delete a configuration for the corresponding non-3GPP identifier, or may request, through an application or OAM, provisioning of the corresponding non-3GPP identifier and information in a 5G core network, and may not attempt PDU session modification until the corresponding identifier is re-provisioned in the 5G core network.

When receiving, as a rejection result for a PDU session modification request and a reason for the rejection, that a requested non-3GPP identifier is not available in a network, a UE or a 5G-RG may modify or delete a configuration for the requested non-3GPP identifier, or may request, through an application or OAM, provisioning of the corresponding non-3GPP identifier and information in a 5G core network, and the UE or the 5G-RG may not attempt PDU session modification until the rejected non-3GPP identifier and non-3GPP identifier information are re-provisioned in the 5G core network.

When a new DNS server address is provided to a UE in a PCO, the UE may refresh all EAS information (for example, a DNS cache) bound to a PDU session.

In operation S530, an (R)AN may acknowledge an N2 PDU session request by transmitting, to an AMF, an N2 PDU session Ack (N2 SM information (a list of approved/rejected QoS (Quality of Service) flow identifiers (QoS Flow Identifier, QFI), AN tunnel information, a PDU session ID, secondary RAT usage data, a TL container, a BAT offset, periodicity, configured QoS flow status (active/inactive) (one of the following: congestion information monitoring, ECN marking for L4S in a PSA UPF, ECN marking for L4S in an NG-RAN), a PDU set based processing support indication), user location information) message.

When dual connectivity is used and one or more QFIs are added to a PDU session, a master RAN node may assign one or more of these QFIs to an NG-RAN node that has not previously participated in the PDU session. In this case, AN tunnel information may include a new N3 tunnel endpoint assigned for the QFI allocated to a new NG-RAN node. Similarly, when one or more QFIs are removed in a PDU session, an (R)AN node may no longer participate in the PDU session, and the corresponding tunnel endpoint may be removed from AN tunnel information.

When an NG-RAN cannot fulfill user plane security enhancement information for a corresponding QoS profile (for example, exceeding a UE integrity protection maximum data rate), the NG-RAN may reject a QFI. An (R)AN receiving a QoS monitoring request may reject performing QoS monitoring due to, for example, (R)AN load conditions.

An (R)AN may reject addition or modification of a QoS flow due to UE-Slice-MBR handling. When an (R)AN rejects addition or modification of a QoS flow, an SMF may be required to enable a UE to appropriately update QoS rules and QoS flow level QoS parameters related to the corresponding QoS flow. An NG-RAN may include, in N2 SM information, a PDU set based processing support indication.

When secondary RAT usage reporting is configured in a PLMN, an NG-RAN node may provide an RAN usage data report. User location information may include a serving cell ID and, when dual connectivity is activated for a UE, a PSCell ID.

When redundant transmission is not activated in a PDU session and an SMF indicates, to an RAN, that one of QoS flows is to perform redundant transmission, the RAN may include additional AN tunnel information in N2 SM information.

When interaction with a TSN deployed in a transport network is supported, an NG-RAN supports an AN-TL, and an NG-RAN receives, from an SM/CUC in operation S440, a TL-Container including a set-request, an NG-RAN/AN-TL may include, in N2 SM information, a TL-Container including a set-response.

When an NG-RAN determines a BAT offset and optionally determines periodicity, the NG-RAN may provide the BAT offset through N2 SM information and may optionally provide the periodicity.

An AMF may transfer, to an SMF, N2 SM information and user location information received from an AN through an Nsmf_PDUSession_UpdateSMContext service operation (S540). The SMF may respond by using an Nsmf_PDUSession_UpdateSMContext response (S542).

When N2 SM information indicates a failure of an entire N2 SM request (that is, when no part of the N2 SM request is successful in an (R)AN), an SMF may assume that a NAS PDU provided in operations S430, S440, and S450 is not delivered from an NG-RAN to a UE. In this case, when a PDU session modification is triggered by a UE, the SMF may reject the PDU session modification by including, in the Nsmf_PDUSession_UpdateSMContext response of operation S542, an N1 SM container including a PDU session modification reject message. In this case, operations S550 and S552 described later may be omitted.

Alternatively, an SMF may assume that a NAS PDU is successfully transmitted to a UE. When an (R)AN rejects a QFI, the SMF may be required, as necessary, to enable a UE to update QoS rules and QoS flow level QoS parameters for a QoS flow associated with QoS rules of the UE. The SMF may trigger, after operations S630 and S632, a separate NAS PDU session modification procedure so that the UE aligns an SM context of the PDU session.

In operations S550 and S552, an SMF may send, to a UPF, an N4 session modification request message to update an N4 session of the UPF related to PDU session modification. Detailed operations of operations S550 and S552 may refer to the above-described operations S420 and S422. For example, a UL packet including a QFI of a new QoS flow or a modified QoS flow may be transmitted. When not already updated in operation S420, the SMF may update the UPF with N4 rules related to a new QoS flow, a modified flow, or a deleted QoS flow.

When an RAN returns additional AN tunnel information in operation S530, an SMF may notify the AN tunnel information to a UPF for redundant transmission. In a case of redundant transmission through two I-UPFs, the SMF may provide AN tunnel information to the two I-UPFs. When a UPF allocates CN tunnel information of the two I-UPFs in operation S422, the SMF may also provide DL CN tunnel information of the two I-UPFs to a UPF (PSA) (S550).

When QoS monitoring is activated for a QoS flow, an SMF may provide, to a UPF through an N4 session modification request message, an N4 rule including a QoS monitoring policy generated according to information received in operation S320 (S550).

When an SMF receives a port number and a port management information container (PMI) from a PCF in operation S410, and the port number matches an NW-TT port number of the PDU session, the SMF may include the port management information container in an N4 session modification request (S550). When the port management information container is included in the N4 session modification request, a UPF may also include the port management information container in an N4 session modification response (S552).

When an SMF determines to activate ECN marking for L4S through a PSA UPF, QoS flow level ECN marking for an L4S marker may be transmitted, through N4, from the SMF to the PSA UPF (S550).

When N2 SM information includes a PDU set based processing support indication and there is a PCC rule having a PDU set QoS parameter for DL, an SMF may configure a PSA UPF to activate PDU set identification and marking for a QoS flow (S550).

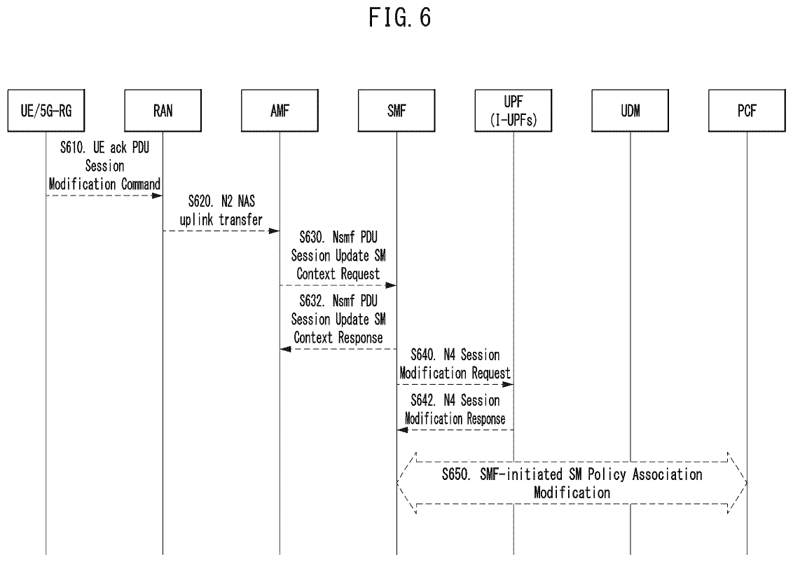

As shown in FIG. 6, each operation may be performed including parameters associated with a PDU session modification procedure affected by related/connection information of a non-3GPP device that is recognized by a UE or a 5G-RG and is associated with the UE or the 5G-RG.

In operation S610, a UE or a 5G-RG may confirm a PDU session modification command by transmitting a NAS message (PDU session ID, N1 SM container (PDU session modification command acknowledgement, [port management information container])) message.

In operation S620, an (R)AN may forward the NAS message to an AMF.

An AMF may transfer, to an SMF through an Nsmf_PDUSession_UpdateSMContext service operation, an N1 SM container (PDU session modification command acknowledgement) and user location information received from an (R)AN (S630). The SMF may respond with an Nsmf_PDUSession_UpdateSMContext response (S632).

When a modification initiated by an SMF is deletion of a QoS flow (for example, triggered by a PCF) that does not include a QoS flow associated with a default QoS rule and the SMF does not receive a response from a UE, the SMF may indicate that a state of the QoS flow is to be synchronized with the UE (S632).

When interworking with a TSN deployed in a transport network is supported, for all QoS flows including a TSC support container, an SMF/CUC may derive merged stream requirements. When an AN-TL and a CN-TL are supported, the SMF/CUC may derive merged stream requirements by using information provided in get-responses stored during a PDU session establishment procedure.

An SMF/CUC may provide, to a TN CNC, merged stream requirements of a talker group and a listener group by interacting with a CNC deployed in a transport network. A TN CNC may select each path and calculate a schedule of a TN by using the merged stream requirements as an input.

A TN CNC may provide, to an SMF/CUC, a status group including merged end station communication configurations based on a processing result.

An SMF may transmit, to a UPF, an N4 session modification request (N4 session ID) message to update an N4 session of the UPF related to PDU session modification (S640). In a case of a PDU session of an Ethernet PDU session type, the SMF may notify, to the UPF, to add or remove an Ethernet packet filter set and forwarding rules.

A UPF affected in a PDU session modification procedure may vary according to modified QoS parameters and a deployment manner. For example, when session AMBR of a PDU session having a UL CL changes, only the UL CL may be involved. This content may also apply to operations S550 and S552.

In operation S650, when an SMF interacts with a PCF in operation S320 or operation S410, the SMF may notify, to the PCF, whether an SMF initiated SM policy association modification procedure can be performed to enforce a PCC decision.

When a 5GS bridge/router information availability trigger is activated and an SMF receives a port management information container from a UE or a UPF, the SMF may provide, to a PCF in operation S650, a port management information container and a port number of a related port.

When a 5GS bridge/router information availability trigger is activated and an SMF receives a user plane node management information container from a UPF, the SMF may provide the user plane node management information container to a PCF.

When a trigger for notification for a BAT offset is activated and an SMF receives a BAT offset and/or periodicity from an RAN, the SMF may provide, to a PCF, the BAT offset and/or the periodicity (S650).

FIG. 7 is an operation flowchart illustrating a session management method for utilizing a non-3GPP device in a mobile communication network according to an exemplary embodiment of the present disclosure.

As shown in FIG. 7, a session management method of a mobile communication network according to an exemplary embodiment of the present disclosure may include an operation S710 in which a core network, by using an access and mobility management function (AMF), receives, from a user equipment (UE) or a 5G residential gateway (5G-RG), a packet data unit (PDU) session modification request to which non-3GPP device connection information is applied, together with the non-3GPP device connection information (Non-3GPP Device Connection Information, N3DCI). The session management method may further include an operation S730 in which the core network, by using one or more of a session management function (SMF) or a policy control function (PCF), determines whether to reject the PDU session modification request.

In the session management method of the mobile communication network according to an exemplary embodiment of the present disclosure, in operation S730 of determining whether to reject the PDU session modification request, whether to reject the PDU session modification request may be determined based on whether a non-3GPP device identifier included in the non-3GPP device connection information applied to the PDU session modification request is available according to information stored in a unified data repository (UDR) for the UE or the 5G-RG.

In the session management method of the mobile communication network according to an exemplary embodiment of the present disclosure, operation S730 of determining whether to reject the PDU session modification request may include an operation S740 of determining whether a non-3GPP device identifier included in the non-3GPP device connection information applied to the PDU session modification request is available by using a unified data repository (UDR); an operation S750 of determining whether to reject, by using the PCF, a session management policy association modification request generated based on the PDU session modification request, based on whether the non-3GPP device identifier is available; and an operation S760 of rejecting, by using the SMF, the PDU session modification request when the session management policy association modification request is rejected by the PCF.

In the session management method of the mobile communication network according to an exemplary embodiment of the present disclosure, operation S730 of determining whether to reject the PDU session modification request may further include an operation of, when the session management policy association modification request is rejected, notifying, by using the PCF, the SMF of rejection of the session management policy association modification request indicating that the non-3GPP device identifier is not available for the UE or the 5G-RG.

The session management method of the mobile communication network according to an exemplary embodiment of the present disclosure may further include an operation of, when the PDU session modification request is rejected, notifying, by using the SMF, the UE or the 5G-RG, via the AMF, of rejection of the PDU session modification request together with a cause code indicating that the non-3GPP device identifier is not available for the UE or the 5G-RG. This operation may be performed with reference to operations S510 to S520 of FIG. 5 described above.

The session management method of the mobile communication network according to an exemplary embodiment of the present disclosure may further include an operation S720 in which the core network, by using the SMF, receives, from the AMF, a session management context update request of a PDU session generated based on the PDU session modification request.

The session management method of the mobile communication network according to an exemplary embodiment of the present disclosure may further include an operation S780 in which the core network, by using the SMF and the PCF, updates session management context information based on the PDU session modification request so that the non-3GPP device connection information is applied.

Some or all of operation S710 may be performed by operation S310 of FIG. 3, etc.

Some or all of operation S720 may be performed by operation S312 or operation S350, etc., of FIG. 3.

In an exemplary embodiment of the present disclosure, operations S730, S740, S750, and S760 may be performed as a portion of operation S410 of FIG. 4 described above. In an alternative exemplary embodiment of the present disclosure, operations S730, S740, S750, and S760 may be performed before operation S410 is performed.

In an exemplary embodiment of the present disclosure, operation S780 may correspond to operation S410. In an alternative exemplary embodiment of the present disclosure, operation S410 may implement a portion of operation S780, and operation S780 may further include operations after operation S410 (for example, operations S420, S422, S550, S552, S640, S642, and S650).

FIG. 8 is an operation flowchart illustrating a session management method for utilizing a non-3GPP device in a mobile communication network according to another exemplary embodiment of the present disclosure.

As shown in FIG. 8, a session management method of a mobile communication network according to another exemplary embodiment of the present disclosure may include an operation S710 in which a core network, by using an access and mobility management function (AMF), receives, from a user equipment (UE) or a 5G residential gateway (5G-RG), a packet data unit (PDU) session modification request to which non-3GPP device connection information (Non-3GPP Device Connection Information) is applied. The session management method may further include an operation S860 in which the core network transfers, via the AMF, a PDU session context update result or a PDU session modification result to which the non-3GPP device connection information is applied, to the UE or the 5G residential gateway (5G-RG).

The session management method of the mobile communication network according to an exemplary embodiment of the present disclosure may further include an operation S720 in which the core network, by using a session management function (SMF), receives, from the AMF, a session management context update request generated based on the PDU session modification request; and an operation S800 in which the core network, by using the SMF and the policy control function (PCF), performs a session management policy association modification procedure for differentiated QoS handling for traffic with the UE or the 5G-RG, based on a non-3GPP device identifier included in the non-3GPP device connection information.

In the session management method of the mobile communication network according to an exemplary embodiment of the present disclosure, operation S800 of performing the session management policy association modification procedure may include an operation S820 in which the core network generates or updates, by using the PCF, a policy and charging control (PCC) rule based on the non-3GPP device identifier and a user plane address corresponding to the non-3GPP device identifier; an operation S830 in which the core network determines, by using the PCF, a quality of service (QoS) parameter in the PCC rule based on the non-3GPP device identifier or an operator policy (Operator Policy); and an operation S840 in which the core network updates, by using the SMF, a session management context for differentiated QoS handling for traffic with the UE or the 5G-RG, based on the QoS parameter.

In the session management method of the mobile communication network according to an exemplary embodiment of the present disclosure, in operation S830 of determining the QoS parameter in the PCC rule, the QoS parameter in the PCC rule may be determined based on a QoS reference or an individual QoS parameter related to the non-3GPP device identifier, obtained from a unified data repository (UDR) by using the non-3GPP device identifier.

The session management method of the mobile communication network according to an exemplary embodiment of the present disclosure may further include, after receiving the session management context update request, an operation of, by using the SMF, updating session management information of a user plane function (UPF) so that the non-3GPP device connection information is applied. This operation may be performed with reference to operations S420 and S422 of FIG. 4.

In the session management method of the mobile communication network according to an exemplary embodiment of the present disclosure, operation S860 of transferring, from the SMF to the UE or the 5G residential gateway (5G-RG) via the AMF, the PDU session context update result or the PDU session modification result may include operations S430, S440, and S450 in which the core network responds, by using the SMF, to the AMF with the update result of a PDU session context to which the non-3GPP device connection information is applied or the PDU session modification result; and operations S510, and S520 in which the core network notifies, by using the AMF, the UE or the 5G residential gateway (5G-RG) of the update result of the PDU session context to which the non-3GPP device connection information is applied or the PDU session modification result.

Some or all of operation S800 may be performed by operations S410, S420, and S422 of FIG. 4 described above, etc. Operation S800 may further include an operation S810 of determining whether to reject a PDU session modification request before operation S820. In this case, some or all of operation S810 may be performed by operations S730, S740, S750, and S760 of FIG. 7, etc.

Referring to the exemplary embodiments of FIGS. 1 to 8 together, a procedure for controlling session management and a session management policy for a non-3GPP device associated with a UE or a 5G-RG and identified by the UE or the 5G-RG is disclosed.

The SMF may notify user location information related to PDU session modification to all entities that have subscribed to the service.

When performance of an AF affecting traffic routing is triggered, the SMF may reconfigure a user plane of a PDU session.

When interaction with a TSN deployed in a transport network is supported, InterfaceConfiguration is included in a state group from the TN CNC to the SMF/CUC in operations S630 and S632, and AN-TL/CN-TL is supported, the SMF/CUC may initiate a PDU session modification procedure as disclosed in operation S340.

When content for requested non-3GPP device identifier information is not stored in the UDR, a default QoS rule may be assigned for traffic of the non-3GPP device identifier, or a request may be rejected.

When the UE/5G-RG binds a device identifier to a non-3GPP device, QoS differentiation may be performed within a PDU session for user data transmission between the UE and a data network (DN) (using different QoS flows) or between PDU sessions. When a non-3GPP device shares a PDU session, the UE/5G-RG may provision a QoS flow through a PDU session modification procedure.

The UE/5G-RG may send, to the SMF, non-3GPP device connection information including a device identifier of a non-3GPP device and a user plane address in an NAS-SM message, and the SMF may deliver the device identifier and, optionally when needed, the user plane address to the PCF. The PCF may consider the device identifier information retrieved from the UDR in a policy decision. The device identifier may be used to retrieve information from the UDR. The user plane address of the non-3GPP device may be a UE IP address and/or a port range in the case of an IPv4 or IPv6 address for an IP PDU session type, and may be a MAC address and/or a VLAN tag ID associated with traffic of the non-3GPP device in the case of an Ethernet PDU session type.

The SMF may receive a non-3GPP device identifier from the UE, and may optionally receive a user plane address corresponding to the non-3GPP device identifier. When a policy control request trigger is satisfied, the SMF may send, to the PCF, the non-3GPP device identifier and, optionally when needed, the user plane address of the non-3GPP device.

When receiving non-3GPP device connection information, the PCF may retrieve, from a unified data repository (UDR), corresponding non-3GPP device identifier information and information stored in association with the non-3GPP device identifier information (for example, applicable QoS-related information), through non-3GPP device identifier information of the non-3GPP device identifier in the non-3GPP device connection information.

The PCF may create a PCC rule based on whether retrieved non-3GPP device information exists and based on non-3GPP device identifier information. For non-3GPP device connection information without non-3GPP device identifier information, the PCF may notify, to the UE or the 5G-RG via the SMF, that non-3GPP device identifier information is absent.

Based on the notification, the UE or the 5G-RG may recognize a non-3GPP device identifier that is not provisioned in the UDR, and may not use the non-3GPP device identifier that is not provisioned. The PCF may determine QoS parameters of a PCC rule based on non-3GPP device identifier information and/or an operator policy. The PCF may store/install a PCC rule in the SMF to activate QoS processing for traffic with a non-3GPP device behind the UE.

When receiving a non-3GPP device identifier and a user plane address as non-3GPP device related/connection information, the PCF may generate and/or update a policy and charging control (PCC) rule based on the non-3GPP device identifier and the user plane address.

The PCF may determine QoS parameters of a PCC rule based on non-3GPP device identifier information retrieved from the UDR and/or an operator policy.

The PCF may install a PCC rule in the SMF to activate QoS processing for traffic with a non-3GPP device behind the UE.

PCC is closely related to the PCF, the SMF, the UPF, the AF, the UDM, etc., and a rule about a policy of using network resources per user service may be defined as PCC.

When the UDR indicates to the PCF that a non-3GPP device identifier is not associated with the UE, the PCF may create a PCC rule that maps traffic of the user plane address to a default QoS flow and may indicate, to the SMF, that the non-3GPP device identifier is not associated with the UE. When receiving an indication that the non-3GPP device identifier is not associated with the UE, the SMF may notify the UE.

When a non-3GPP device identifier is received by being included in an NAS-SM message, the SMF may indicate, to the UE or the 5G-RG, that the non-3GPP device identifier is not associated with the UE or the 5G-RG by using a PDU session establishment accept message or a PDU session modification request. When a non-3GPP device identifier is received in a DHCPv6 request message, the SMF may respond with a DHCPv6 error code (for example, NoBinding or UnspecFail) to indicate that the non-3GPP device identifier is not associated with the UE.

By using a rejection message for a PDU session modification request and a cause code notifying that a non-3GPP device identifier does not exist in the UDR, it may be indicated to the UE or the 5G-RG that the non-3GPP device identifier is not associated with the UE or the 5G-RG and that no policy other than a default QoS policy can be used in a 5G network.

An NF service consumer may request SM policy association creation and may provide parameters related to a PDU session to the PCF.

The AMF, the SMF, the PCF, and the UDM/UDR may share, regarding policy information for a PDU session and a policy control request trigger for session management policy association, a non-3GPP device identifier and information on a non-associated non-3GPP device identifier, and may transfer the non-3GPP device identifier and the information to the UE, the 5G residential gateway (5G-RG), and/or the (R)AN.

As shown in FIGS. 1 to 8, a scenario of a non-3GPP device connected via a UE is disclosed. QoS differentiation may be applied to traffic generated by a non-3GPP device or directed to a non-3GPP device. A non-3GPP device may refer to a device that does not directly use NAS and is not authenticated by a 5G core network.

Differentiated QoS for a non-3GPP device connected via a 5G-RG may be implemented similarly to differentiated QoS for a non-3GPP device connected via a UE.

A non-3GPP device identifier (Non-3GPP Device Identifier) may be unique within the scope of the UE's SUPI.

The UE or the 5G-RG may bind a non-3GPP device identifier to a non-3GPP device for traffic of the non-3GPP device requiring differentiated QoS. Through the binding, a 5G system may distinguish traffic generated and transmitted from different non-3GPP devices connected via the same UE.

Non-3GPP device identifier information may be stored in the UDR. The non-3GPP device identifier information may include a non-3GPP device identifier and QoS information.

To provision QoS information for a non-3GPP device for which differentiated QoS treatment is required, non-3GPP device identifier information may be defined to include service parameters as follows.

Non-3GPP device identifier information may include a non-3GPP device identifier (Non-3GPP Device Identifier) and a generic string that uniquely identifies a non-3GPP device behind a specific UE. In addition, non-3GPP identifier information may include a QoS reference or individual QoS parameters. In this case, a QoS reference may refer to predefined QoS information. Instead of a QoS reference, individual QoS parameters associated with a flow description may be provided.

The PCF may extract QoS parameters of a PCC rule.

For traffic of a non-3GPP device for which differentiated QoS is required, non-3GPP device connection information (Non-3GPP Device Connection Information) may be transmitted from the UE or the 5G-RG. The non-3GPP device connection information may include a non-3GPP device identifier and an IP address and a port number, or a MAC address and a VLAN tag ID, etc. When the non-3GPP device is connected to the UE or the 5G-RG, the UE may include non-3GPP device connection information in a PDU session modification request delivered to the SMF. The non-3GPP device connection information may include information of one or more non-3GPP devices. The SMF may deliver the non-3GPP device connection information to the PCF for policy control.

When the PCF rejects a session management policy association modification and indicates, based on information stored in the UDR for the UE or the 5G-RG, that a corresponding non-3GPP device identifier included in non-3GPP device connection information is not available in the 5G core network, the SMF may reject a PDU session modification together with a cause code notifying the UE or the 5G-RG that the non-3GPP device identifier is not available in the 5G core network.

Since a PDU session modification request may be rejected if it includes a non-3GPP device identifier that is not stored in the UDR for the UE or the 5G-RG, the UE or the 5G-RG may be recommended not to include parameters unrelated to non-3GPP device connection information in a PDU session modification request requesting differentiated QoS for a non-3GPP device.

In a UE-initiated PDU session modification procedure, the SMF may receive a non-3GPP device identifier and a corresponding user plane address from the UE or the 5G-RG. The SMF may transmit the non-3GPP device identifier and, optionally, the user plane address of the non-3GPP device to the PCF.

The PCF may determine QoS parameters of PCC rules based on non-3GPP device identifier information retrieved from the UDR and/or operator policy.

The PCF may subscribe to updates of non-3GPP device identifier information in the UDR. Further, the PCF may request the SMF to update session management subscription data or may provide required information based on the updates of the non-3GPP device identifier information.

The PCF may provide PCC rules to the SMF to enable differentiated QoS handling for traffic to or from a non-3GPP device behind the UE or the 5G-RG.

When a non-3GPP device identifier received in a PDU session modification request does not exist within non-3GPP device identifier information available for the UE or the 5G-RG, the PCF may indicate to the SMF that one or more non-3GPP device identifiers are not available for the UE.

In this case, the PCF may reject a session management policy association modification. Based on the rejection received from the PCF, the SMF may reject the PDU session modification together with a cause code notifying the UE that at least one non-3GPP device identifier does not exist.

When non-3GPP device identifier information for one or more non-3GPP device identifiers is updated or removed in the UDR, the UDR may notify the PCF of the update or removal of the non-3GPP device identifier information through a Nudr_DM_Notify service.

When there are PCC rules associated with traffic related to updated or removed non-3GPP device identifiers in a PDU session, the PCF may remove or update the PCC rules and may request initiation of a PCF-initiated session management policy association modification. In this case, the SMF may remove or update corresponding QoS and N4 rules.

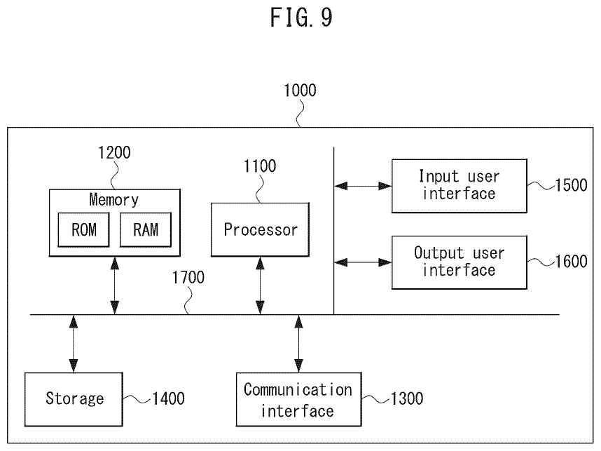

FIG. 9 is a conceptual diagram illustrating an example of a generalized computing system in which one or more of a UE associated with a non-3GPP device, an (R)AN, entities within a core network 200, or sensing entities interacting with the core network 200 and participating in a sensing process may be implemented to perform one or more of the processes of FIGS. 1 through 8.

One or more of sensing, control, computation, data processing, data transmission, or data reception processes performed by a UE associated with a non-3GPP device, an (R)AN, entities performing at least part of network functions within the core network 200, and sensing entities involved in a target sensing process according to the embodiments illustrated in FIGS. 1 through 8 may be executed by the computing system 1000 of FIG. 9.

One or more of PDU session management, processing, management, control, computation, storage, data transmission, data reception, etc. of non-3GPP device connection information and non-3GPP device identifier information performed by a UE associated with a non-3GPP device, an (R)AN, and entities performing at least part of network functions within the core network 200 according to the embodiments illustrated in FIGS. 1 through 8 may be executed by the computing system 1000 of FIG. 9.

As shown in FIG. 9, a computing system 1000 according to an exemplary embodiment of the present disclosure may be configured to include a processor 1100, a memory 1200, a communication interface 1300, a storage device 1400, an input interface 1500, an output interface 1600, and a bus 1700.

The computing system 1000 according to an embodiment of the present disclosure may include at least one processor 1100 and the memory 1200 storing program instructions instructing the at least one processor 1100 to perform at least one operation. At least some of the operations of the method according to an embodiment of the present disclosure may be performed by the at least one processor 1100 loading and executing the program instructions from the memory 1200.

The processor 1100 may include a central processing unit (CPU) or a graphics processing unit (GPU) or may be implemented by another kind of dedicated processor suitable for performing the method of the present disclosure.

Each of the memory 1200 and the storage device 1400 may be comprised of at least one of a volatile storage medium and a non-volatile storage medium. For example, the memory 1200 may be comprised of at least one of a read only memory (ROM) and a random access memory (RAM).

Additionally, the computing system 1000 may include the communication interface 1300 that performs communications through a wireless communication network.

Additionally, the computing system 1000 may further include the storage device 1400, the input interface 1500, and the output interface 1600.

Additionally, the components of the computing system 1000 may be connected to each other by the system bus 1700 to communicate with each other.

A communication network system controlling sensing according to an embodiment of the present disclosure may include at least one entity, and the at least one entity may include a memory 1200 storing one or more computer-readable instructions and a processor 1100 executing the one or more instructions.

As described above, the at least one entity in the communication network system controlling sensing may implement at least one network function illustrated in FIGS. 1 through 9 according to embodiments of the present disclosure.

The at least one entity in the communication network system controlling sensing may perform the procedures and operations illustrated in FIGS. 1 through 9.

The computing system 1000 according to an exemplary embodiment of the present disclosure may be any data processing device capable of communications through a network such as a desktop computer, a laptop computer, a notebook PC, a smartphone, a tablet PC, a mobile phone, a smart watch, smart glasses, an e-book reader, a portable multimedia player (PMP), a portable game console, a navigation device, a digital camera, a digital multimedia broadcasting (DMB) player, a digital audio recorder, a digital audio player, a digital video recorder, a digital video player, and a personal digital assistant (PDA).

The device and method according to exemplary embodiments of the present disclosure can be implemented by computer-readable program codes or instructions stored on a computer-readable intangible recording medium. The computer-readable recording medium includes all types of recording device storing data which can be read by a computer system. The computer-readable recording medium may be distributed over computer systems connected through a network so that the computer-readable program or codes may be stored and executed in a distributed manner.

The computer-readable recording medium may include a hardware device specially configured to store and execute program instructions, such as a ROM, RAM, and flash memory. The program instructions may include not only machine language codes generated by a compiler, but also high-level language codes executable by a computer using an interpreter or the like.

Some aspects of the present disclosure described above in the context of the device may indicate corresponding descriptions of the method according to the present disclosure, and the blocks or devices may correspond to operations of the method or features of the operations. Similarly, some aspects described in the context of the method may be expressed by features of blocks, items, or devices corresponding thereto. Some or all of the operations of the method may be performed by (or using) a hardware device such as a microprocessor, a programmable computer, or electronic circuits, for example. In some exemplary embodiments, one or more of the most important operations of the method may be performed by such a device.

In some exemplary embodiments, a programmable logic device such as a field-programmable gate array may be used to perform some or all of functions of the methods described herein. In some exemplary embodiments, the field-programmable gate array may be operated with a microprocessor to perform one of the methods described herein. In general, the methods are preferably performed by a certain hardware device.

The description of the disclosure may be merely exemplary in nature and, thus, variations that do not depart from the substance of the disclosure may be intended to be within the scope of the disclosure. Such variations may not be to be regarded as a departure from the spirit and scope of the disclosure. Thus, it will be understood by those of ordinary skill in the art that various changes in form and details may be made without departing from the spirit and scope as defined by the following claims.

What is claimed is:

1. A method for session management in a mobile communication network, comprising:
receiving, by a core network, a packet data unit (PDU) session modification request with non-3GPP device connection information applied from a user equipment (UE) or a 5G residential gateway (5G-RG); and
determining, by the core network, whether to reject the PDU session modification request using at least one of a session management function (SMF) or a policy control function (PCF).

2. The method for session management of claim 1, wherein the determining whether to reject the PDU session modification request, comprises:
determining whether to reject the PDU session modification request based on whether a non-3GPP device identifier included in the non-3GPP device connection information applied to the PDU session modification request is available according to information stored in a unified data repository (UDR) for the UE or 5G-RG.

3. The method for session management of claim 1, wherein the determining whether to reject the PDU session modification request, comprises:
determining using a unified data repository (UDR) whether a non-3GPP device identifier included in the non-3GPP device connection information applied to the PDU session modification request is available;
determining using the PCF whether to reject a session management policy association modification request generated based on the PDU session modification request, based on whether the non-3GPP device identifier is available; and
rejecting the PDU session modification request using the SMF based on the session management policy association modification request being rejected by the PCF.

4. The method for session management of claim 3, wherein the determining whether to reject the PDU session modification request, further comprises:
notifying, using the PCF, a rejection of the session management policy association modification request, to the SMF, indicating that the non-3GPP device identifier is not available for the UE or 5G-RG, based on the session management policy association modification request being rejected.

5. The method for session management of claim 3, based on the PDU session modification request being rejected, further comprising:
notifying, using the SMF, a rejection of the PDU session modification request to the UE or 5G-RG via an access and mobility management function (AMF) together with a cause code notifying that the non-3GPP device identifier is not available for the UE or 5G-RG.

6. The method for session management of claim 1, further comprising:
receiving, by the core network using the SMF, a session management context update request of a PDU session generated based on the PDU session modification request from an access and mobility management function (AMF).

7. The method for session management of claim 1, further comprising:
updating, by the core network using the SMF and the PCF, session management context information based on the PDU session modification request so that the non-3GPP device connection information is applied.

8. A method for session management in a mobile communication network, comprising:
receiving, by a core network, a packet data unit (PDU) session modification request with non-3GPP device connection information applied from a user equipment (UE) or a 5G residential gateway (5G-RG) using an access and mobility management function (AMF); and
transmitting, by the core network, a PDU session context update result or a PDU session modification result to which the non-3GPP device connection information is applied to the UE or the 5G-RG via the AMF.

9. The method for session management of claim 8, further comprising:
receiving, by the core network using a session management function (SMF), a session management context update request generated from the AMF based on the PDU session modification request; and
performing, by the core network using the SMF and a policy control function (PCF), a session management policy association modification procedure for differentiated QoS handling for traffic with the UE or the 5G-RG based on a non-3GPP device identifier included in the non-3GPP device connection information.

10. The method for session management of claim 9, wherein the performing of the session management policy association modification procedure comprises:
generating or updating, by the core network using the PCF, one or more Policy and Charging Control (PCC) rules based on the non-3GPP device identifier and a user plane address corresponding to the non-3GPP device identifier;
determining, by the core network using the PCF, a Quality of Service (QoS) parameter within the one or more PCC rules based on the non-3GPP device identifier or an operator policy; and
updating, by the core network using the SMF, a session management context for differentiated QoS handling for traffic with the UE or the 5G-RG based on the QoS parameter.

11. The method for session management of claim 10, wherein the determining of the QoS parameter within the one or more PCC rules comprises:
determining the QoS parameter in the one or more PCC rules based on an individual QoS parameter or a QoS reference associated with the non-3GPP device identifier obtained using the non-3GPP device identifier from a unified data repository (UDR).

12. The method for session management of claim 9, further comprising:
updating, using the SMF, session management information of a user plane function (UPF) so that the non-3GPP device connection information is applied, after the receiving of the session management context update request.

13. The method for session management of claim 8, wherein the transmitting of the PDU session context update result or the PDU session modification result to the UE or the 5G-RG via the AMF, comprises:
responding, by the core network using the SMF, to the AMF with the PDU session context update result or the PDU session modification result to which the non-3GPP device connection information is applied; and
notifying, by the core network using the AMF, the PDU session context update result or the PDU session modification result to which the non-3GPP device connection information is applied to the UE or the 5G-RG.

14. A communication system, comprising:
at least one entity,
wherein the at least one entity comprises:
a memory storing at least one instruction readable in a computer; and
a processor executing the at least one instruction;
wherein the at least one entity is configured to:
receive a packet data unit (PDU) session modification request with non-3GPP device connection information applied from a user equipment (UE) or a 5G residential gateway (5G-RG) using an access and mobility management function (AMF); and
determine whether to reject the PDU session modification request using at least one of a session management function (SMF) or a policy control function (PCF).

15. The communication system of claim 14, wherein the at least one entity is further configured to:
determine whether to reject the PDU session modification request based on whether a non-3GPP device identifier included in the non-3GPP device connection information applied to the PDU session modification request is available according to information stored in a unified data repository (UDR) for the UE or 5G-RG.

16. The communication system of claim 14, wherein the at least one entity is further configured to:
determine using a unified data repository (UDR) whether a non-3GPP device identifier included in the non-3GPP device connection information applied to the PDU session modification request is available;
determine using the PCF whether to reject a session management policy association modification request generated based on the PDU session modification request, based on whether the non-3GPP device identifier is available; and
reject the PDU session modification request using the SMF based on the session management policy association modification request being rejected by the PCF.

17. The communication system of claim 16, wherein the at least one entity is further configured to:
notify, using the PCF, a rejection of the session management policy association modification request, to the SMF, indicating that the non-3GPP device identifier is not available for the UE or 5G-RG, based on the session management policy association modification request being rejected, and
notify, using the SMF, a rejection of the PDU session modification request to the UE or 5G-RG via an access and mobility management function (AMF) together with a cause code notifying that the non-3GPP device identifier is not available for the UE or 5G-RG.

18. The communication system of claim 14, wherein the at least one entity is further configured to:
transmit a PDU session context update result or a PDU session modification result to which the non-3GPP device connection information is applied to the UE or the 5G-RG via the AMF.

19. The communication system of claim 14, wherein the at least one entity is further configured to:
generate or update, using the PCF, one or more Policy and Charging Control (PCC) rules based on a non-3GPP device identifier included in the non-3GPP device connection information and a user plane address corresponding to the non-3GPP device identifier;
determine, using the PCF, a Quality of Service (QoS) parameter within the one or more PCC rules based on the non-3GPP device identifier or an operator policy; and
update, using the SMF, a session management context for differentiated QoS handling for traffic with the UE or the 5G-RG based on the QoS parameter.

20. The communication system of claim 14, wherein the non-3GPP device connection information comprises:
a user plane address and a device identifier bound to a non-3GPP device for QoS differentiation between PDU sessions to which the UE or the 5G-RG is associated, or for differentiation between QoS flows within a PDU session to which the UE or the 5G-RG is associated.
